(19) United States
(12) Patent Application Publication
(10) Pub. No.: US 2009/0126570 A1
(43) Pub. Date: May 21, 2009

(54) Polymer Functionalized Molecular Sieve/Polymer Mixed Matrix Membranes

(76) Inventors: Chunqing Liu, Schaumburg, IL (US); Stephen T. Wilson, Libertyville, IL (US); David A. Lesch, Hoffman Estates, IL (US); Douglas B. Galloway, Mount Prospect, IL (US)

Correspondence Address: HONEYWELL INTERNATIONAL INC;PATENT SERVICES, 101 COLUMBIA DRIVE, P O BOX 2245 MAIL STOP AB/2B, MORRISTOWN, NJ, 07962, US

(21) Appl. No.: 11/940,554

(22) Filed: Nov. 15, 2007

(51) Int. Cl. B01D 53/22

(52) U.S. Cl. 96/4; 977/779

(57) ABSTRACT

The present invention discloses polymer functionalized molecular sieve/polymer mixed matrix membranes (MMMs) with either no macrovoids or voids of less than several Angstroms at the interface of the polymer matrix and the molecular sieves by incorporating polyethersulfone (PES) or cellulose triacetate (CTA) functionalized molecular sieves into a continuous polyimide or cellulose acetate (CA) polymer matrix. The MMMs, in the form of symmetric dense film, asymmetric flat sheet membrane, or asymmetric hollow fiber have good flexibility and high mechanical strength, and exhibit significantly enhanced selectivity and/or permeability over the polymer membranes made from the corresponding continuous polymer matrices for carbon dioxide/methane (CO₂/CH₄) and hydrogen/methane (H₂/CH₄) separations. The MMMs are suitable for a variety of liquid, gas, and vapor separations such as deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin, iso/normal paraffins separations, and other light gas mixture separations.

### BACKGROUND OF THE INVENTION

This invention pertains to polymer functionalized molecular sieve/polymer mixed matrix membranes (MMMs) with either no macrovoids or voids of less than several Angstroms at the interface of the polymer matrix and the molecular sieves.

Current commercial cellulose acetate (CA) polymer membranes for natural gas upgrading must be improved to continue improvements relative to competitive membrane technologies. It is highly desirable to provide an alternative cost-effective new membrane with higher selectivity and permeability than CA membrane for CO₂/CH₄ and other gas and vapor separations.

Gas separation processes with membranes have undergone a major evolution since the introduction of the first membrane-based industrial hydrogen separation process about two decades ago. The design of new materials and efficient methods will further advance the technology of membrane gas separation processes within the next decade.

The gas transport properties of many glassy and rubbery polymers have been measured as part of the search for materials with high permeability and high selectivity for potential use as gas separation membranes. Unfortunately, an important limitation in the development of new membranes for gas separation applications is a well-known trade-off between permeability and selectivity of polymers. By comparing the data of hundreds of different polymers, Robeson demonstrated that selectivity and permeability seem to be inseparably linked to one another, in a relation where selectivity increases as permeability decreases and vice versa.

Despite concentrated efforts to tailor polymer structure to improve separation properties; current polymeric membrane materials have seemingly reached a limit in the trade-off between productivity and selectivity. For example, many polyimide and polyetherimide glassy polymers such as Ultem® 1000 have much higher intrinsic CO₂/CH₄ selectivities (α_{CO2/CH4}) (˜30 at 50° C. and 690 kPa (100 psig) pure gas tests) than that of cellulose acetate (˜22), which would make them more attractive for gas separation applications than the commercial cellulose acetate membranes. However, these polymers do not have outstanding permeabilities attractive for commercialization compared to current commercial cellulose acetate membrane products, in agreement with the trade-off relationship reported by Robeson. On the other hand, some inorganic membranes such as Si-DDR zeolite and carbon molecular sieve membranes offer much higher permeability and selectivity than polymeric membranes for separations, but are expensive and difficult for large-scale manufacture. Therefore, it is highly desirable to provide an alternate cost-effective membrane with improved separation properties and in a position above the trade-off curves between permeability and selectivity.

Based on the need for a more efficient membrane than polymer and inorganic membranes, a new type of membrane, mixed matrix membranes (MMMs), has been recently developed. Mixed matrix membranes are hybrid membranes containing fillers, such as molecular sieves, dispersed in a polymer matrix.

Mixed matrix membranes have the potential to achieve higher selectivity with equal or greater permeability compared to existing polymer membranes while maintaining the advantages of low cost and easy processability. Much of the research conducted to date on mixed matrix membranes has focused on the combination of a dispersed solid molecular sieving phase, such as molecular sieves or carbon molecular sieves, with an easily processed continuous polymer matrix. For example, see the following patents and published patent applications: U.S. Pat. No. 6,626,980; US 2005/0268782; US 2007/0022877; and U.S. Pat. No. 7,166,146. The sieving phase in a solid/polymer mixed matrix scenario can have a selectivity that is significantly larger than that of the pure polymer. Therefore, the addition of a small volume fraction of molecular sieves to the polymer matrix can increase the overall separation efficiency significantly. Typical inorganic sieving phases in MMMs include various molecular sieves, carbon molecular sieves, and traditional silica. Many organic polymers, including cellulose acetate, polyvinyl acetate, polyetherimide (commercially Ultem®), polysulfone (commercial Udel®), polydimethylsiloxane, polyethersulfone, and several polyimides (including commercial Matrimid®), have been used as the continuous phase in MMMs.

While the polymer “upper-bound” curve has been surpassed using solid/polymer MMMs, there are still many issues that need to be addressed for large-scale industrial production of these new types of MMMs. For example, voids and defects at the interface of the inorganic molecular sieves and the organic polymer matrix were observed for most of the molecular sieve/polymer MMMs reported in the literature due to the poor interfacial adhesion and poor materials compatibility between the molecular sieve and the polymer. These voids, that are much larger than the diameter of the penetrating molecules, result in reduced overall selectivity for these MMMs. Research has shown that the interfacial region, which is a transition phase between the continuous polymer and the dispersed sieve phases, is of particular importance in forming successful MMMs.

More recently, significant research efforts have been focused on materials compatibility and adhesion at the inorganic molecular sieve/polymer interface of the MMMs in order to achieve separation property enhancements over traditional polymers. For example, Kulkarni et al. and Marand et al. reported the use of organosilicon coupling agent functionalized molecular sieves to improve the adhesion at the sieve particle/polymer interface of the MMMs. See U.S. Pat. No. 6,508,860 and U.S. Pat. No. 7,109,140. Kulkarni et al. also reported the formation of MMMs with minimal macrovoids and defects by using electrostatically stabilized suspensions. See US 2006/0117949.

Despite these reported research efforts, issues of material compatibility and adhesion at the inorganic molecular sieve/polymer interface of the MMMs are still not completely addressed.

A recent patent application, U.S. Ser. No. 11/612,366, filed Dec. 18, 2006, provided one approach to make void and defect free mixed matrix membranes. In that application polymer stabilized molecular sieves were used as the dispersed fillers and at least two different types of polymers as the continuous polymer matrix was disclosed for the first time. In some cases it has now been found, however, that the use of at least two different types of polymers as the continuous polymer matrix may result in phase separation between the two different types of polymers, which results in voids and defects and decreased selectivity. Therefore, it is very important to select two or more compatible polymers as the continuous blend polymer matrix and control their weight ratios to avoid phase separation. The current invention provides a solution to problems found with our earlier invention. It has been discovered that mixed matrix membranes with either no macrovoids or voids of less than several Angstroms at the interface of the polymer matrix and the molecular sieves can be successfully prepared, for example, by incorporating polyethersulfone (PES) functionalized molecular sieves such as AlPO-14 into a single continuous polyimide polymer matrix. It has been demonstrated in the current invention that the avoidance of the addition of a second or more types of polymers as a part of the continuous polymer matrix, while it may result in phase separation, can prevent the formation of voids and produce defect free MMMs. Therefore, a greatly simplified and easily performed procedure, which is easier for large-scale membrane manufacture, is disclosed in the present invention for the fabrication of void and defect free molecular sieve/polymer MMMs.

### SUMMARY OF THE INVENTION

This invention pertains to novel void-free and defect-free polymer functionalized molecular sieve/polymer mixed matrix membranes (MMMs). More particularly, the invention pertains to a novel method of making and methods of using polymer functionalized molecular sieve/polymer MMMs.

The present invention discloses novel polymer functionalized molecular sieve/polymer mixed matrix membranes (MMMs) with either no macrovoids or voids of less than several Angstroms at the interface of the polymer matrix and the molecular sieves by incorporating polymer (e.g., polyethersulfone) functionalized molecular sieves into a continuous polymer (e.g., polyimide) matrix. The MMMs such as PES functionalized AlPO-14/polyimide MMMs, are manufactured in the form of symmetric dense films, asymmetric flat sheet membrane, asymmetric hollow fiber membranes or other type of structure. These MMMs have good flexibility and high mechanical strength, and exhibit significantly enhanced selectivity and/or permeability over the polymer membranes made from the corresponding continuous polymer for carbon dioxide/methane (CO₂/CH₄) and hydrogen/methane (H₂/CH₄) separations as well as other separations.

The present invention provides a novel method of making polymer functionalized molecular sieve/polymer MMMs free of voids and defects, using stable polymer functionalized molecular sieve/polymer suspensions (or so-called “casting dope”) containing dispersed polymer functionalized molecular sieve particles and a dissolved continuous polymer matrix in a mixture of organic solvents. The method comprises the steps of: (a) first dispersing the molecular sieve particles in a mixture of two or more organic solvents by ultrasonic mixing and/or mechanical stirring or other method to form a molecular sieve slurry; (b) dissolving a suitable polymer in the molecular sieve slurry to functionalize the outer surface of the molecular sieve particles; (c) dissolving a polymer that serves as a continuous polymer matrix in the polymer functionalized molecular sieve slurry to form a stable polymer functionalized molecular sieve/polymer suspension and; (d) fabricating an MMM in a form of symmetric dense film (FIG. 1), asymmetric flat sheet (FIG. 2), or asymmetric hollow fiber using the polymer functionalized molecular sieve/polymer suspension.

In some cases a later treatment step of the membrane can be added to improve selectivity but does not otherwise significantly change or damage the membrane, or cause the membrane to lose performance with time. This treatment step can involve coating the top surface of the MMM with a thin layer of material such as a polysiloxane, a fluoro-polymer, a thermally curable silicone rubber, or a UV radiation curable epoxy silicone (FIG. 3).

The molecular sieves in the MMMs provided in this invention can have selectivity and/or permeability that are significantly higher than the pure polymer membranes for separations. Addition of a small weight percent of molecular sieves to the polymer matrix, therefore, can increase the overall separation efficiency significantly. The molecular sieves that are used include microporous and mesoporous molecular sieves, carbon molecular sieves, and porous metal-organic frameworks (MOFs). The preferred microporous molecular sieves are selected from alumino-phosphate molecular sieves such as AlPO-18, AlPO-14, AlPO-53, AlPO-52, and AlPO-17, aluminosilicate molecular sieves such as UZM-25, UZM-5 and UZM-9, silico-alumino-phosphate molecular sieves such as SAPO-34, and mixtures thereof.

More importantly, the molecular sieve particles dispersed in the concentrated suspension are functionalized by a suitable polymer such as polyethersulfone (PES), which results in the formation of either polymer-O-molecular sieve covalent bonds via reactions between the hydroxyl (—OH) groups on the surfaces of the molecular sieves and the hydroxyl (—OH) groups at the polymer chain ends or at the polymer side chains of the molecular sieve stabilizers such as PES or hydrogen bonds between the hydroxyl groups on the surfaces of the molecular sieves and functional groups such as ether groups on the polymer chains. The functionalization of the surfaces of the molecular sieves using a suitable polymer provides good compatibility and an interface substantially free of voids and defects at the molecular sieve/polymer used to functionalize the molecular sieves/polymer matrix interface. Therefore, voids and defects free polymer functionalized molecular sieve/polymer MMMs with significant separation property enhancements over traditional polymer membranes and over those prepared from suspensions containing the same polymer matrix and same molecular sieves but without polymer functionalization have been successfully prepared using these stable polymer functionalized molecular sieve/polymer suspensions. An absence of voids and defects at the interface increases the likelihood that the permeating species will be separated by passing through the pores of the molecular sieves in MMMs rather than passing unseparated through voids and defects. The MMMs fabricated using the present invention combine the solution-diffusion mechanism of polymer membrane and the molecular sieving and sorption mechanism of molecular sieves (FIG. 4), and assure maximum selectivity and consistent performance when comparing different membrane samples comprising the same molecular sieve/polymer composition.

The polymer used to functionalize the molecular sieve particles in the MMMs of the present invention forms good adhesion at the molecular sieve/polymer used to functionalize molecular sieves interface via hydrogen bonds or molecular sieve-O-polymer covalent bonds. In addition, the polymer used to functionalize the molecular sieve particles in the MMMs is an intermediate to improve the compatibility of the molecular sieves with the continuous polymer matrix and stabilizes the molecular sieve particles in the concentrated suspensions. The homogeneously suspended polymer functionalized molecular sieve particles in the suspension allowing their uniform dispersion in the continuous polymer matrix of the final MMMs. The MMM, particularly symmetric dense film MMM, asymmetric flat sheet MMM, or asymmetric hollow fiber MMM, are fabricated from the stabilized suspension. An MMM prepared by the present invention comprises uniformly dispersed polymer functionalized molecular sieve particles throughout the continuous polymer matrix. The continuous polymer matrix generally is a glassy polymer such as a polyimide. The polymer used to functionalize the molecular sieve particles is preferably a polymer different from the continuous polymer matrix.

The MMMs, particularly symmetric dense film MMMs, asymmetric flat sheet MMMs, or asymmetric hollow fiber MMMs, fabricated by the method described in the current invention exhibit significantly enhanced selectivity and/or permeability over both polymer membranes prepared from the polymer matrix and over those prepared from suspensions containing the same polymer matrix and same molecular sieves but lacking polymer functionalization. This method is suitable for large scale membrane production and can be integrated into commercial polymer membrane manufacturing processes.

The invention also provides a process for separating at least one gas from a mixture of gases using the MMMs described in the present invention, the process comprising: (a) providing an MMM comprising a polymer functionalized molecular sieve filler material uniformly dispersed in a continuous polymer matrix which is permeable to said at least one gas; (b) contacting the mixture on one side of the MMM to cause said at least one gas to permeate the MMM; and (c) removing from the opposite side of the membrane a permeate gas composition comprising a portion of said at least one gas which permeated said membrane.

The MMMs of the present invention are suitable for a variety of liquid, gas, and vapor separations such as deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin, iso/normal paraffins separations, and other light gas mixture separations.

The invention can be better understood with reference to the following drawings and description.

### BRIEF DESCRIPTION OF THE DRAWINGS

FIG. 1 is a schematic drawing of a symmetric mixed matrix dense film containing dispersed polymer functionalized molecular sieves and a continuous polymer matrix;

FIG. 2 is a schematic drawing of an asymmetric mixed matrix membrane containing dispersed polymer functionalized molecular sieves and a continuous polymer matrix fabricated on a porous support substrate;

FIG. 3 is a schematic drawing of a post-treated asymmetric mixed matrix membrane containing dispersed polymer functionalized molecular sieves and a continuous polymer matrix fabricated on a porous support substrate and coated with a thin polymer layer;

FIG. 4 is a schematic drawing illustrating the separation mechanism of molecular sieve/polymer mixed matrix membranes combining the solution-diffusion mechanism of polymer membranes and the molecular sieving mechanism of molecular sieve membranes;

FIG. 5 is a schematic drawing showing the formation of polymer functionalized molecular sieve via covalent bonds;

FIG. 6 is a chemical structure drawing of poly(BTDA-PMDA-TMMDA);

FIG. 7 is a chemical structure drawing of poly(BTDA-PMDA-ODPA-TMMDA);

FIG. 8 is a chemical structure drawing of poly(DSDA-TMMDA);

FIG. 9 is a chemical structure drawing of poly(BTDA-TMMDA);

FIG. 10 is a chemical structure drawing of poly(DSDA-PMDA-TMMDA);

FIG. 11 is a chemical structure drawing of poly(6FDA-m-PDA);

FIG. 12 is a chemical structure drawing of poly(6FDA-m-PDA-DABA).

FIG. 13 is a plot showing CO₂/CH₄ separation performance of “control” poly(DSDA-TMMDA) and AlPO-14/PES/poly(DSDA-TMMDA) mixed matrix dense films of the present invention at 50° C. and 690 kPa (100 psig), as well as Robeson's 1991 polymer upper limit data for CO₂/CH₄ separation at 35° C. and about 345 kPa (50 psig).

FIG. 14 is a plot showing H₂/CH₄ separation performance of “control” poly(DSDA-TMMDA) and AlPO-14/PES/poly(DSDA-TMMDA) mixed matrix dense films of the present invention at 50° C. and 690 kPa (100 psig), as well as Robeson's 1991 polymer upper limit data for H₂/CH₄ separation at 35° C. and about 345 kPa (50 psig).

### DETAILED DESCRIPTION OF THE INVENTION

Mixed matrix membrane (MMM) containing dispersed molecular sieve fillers in a continuous polymer matrix have been found to retain polymer processability and have improved selectivity for separating gases and liquid mixtures due to the superior molecular sieving and sorption properties of the molecular sieve materials. These MMMs have received worldwide attention during the last two decades. In many instances, however, the aggregation of the molecular sieve particles in the polymer matrix and the poor adhesion at the interface of the molecular sieve particles and the polymer matrix in MMMs still need to be addressed. These deficiencies can result in poor mechanical and processing properties and poor permeation performance. Material compatibility and good adhesion between the polymer matrix and the molecular sieve particles are needed to achieve enhanced selectivity of the MMMs. Poor adhesion that results in voids and defects around the molecular sieve particles that are larger than the pores inside the molecular sieves decrease the overall selectivity of the MMM by allowing the gas or liquid species to bypass the pores of the molecular sieves. Thus, the MMMs can at most only exhibit the selectivity of the continuous polymer matrix.

The present invention pertains to novel void and defect free polymer functionalized molecular sieve/polymer mixed matrix membranes (MMMs). More particularly, the invention pertains to a novel method of making and methods of using these polymer functionalized molecular sieve/polymer MMMs. The MMMs are prepared by using a stabilized concentrated suspension (also called “casting dope”) containing uniformly dispersed polymer functionalized molecular sieves and a continuous polymer matrix. The term “mixed matrix” as used in this invention means that the membrane comprises a continuous polymer matrix and discrete polymer functionalized molecular sieve particles uniformly dispersed throughout the continuous polymer matrix. Often it is a layer or layers within the membrane that is this combination of continuous polymer matrix and discrete polymer functionalized molecular sieve particles.

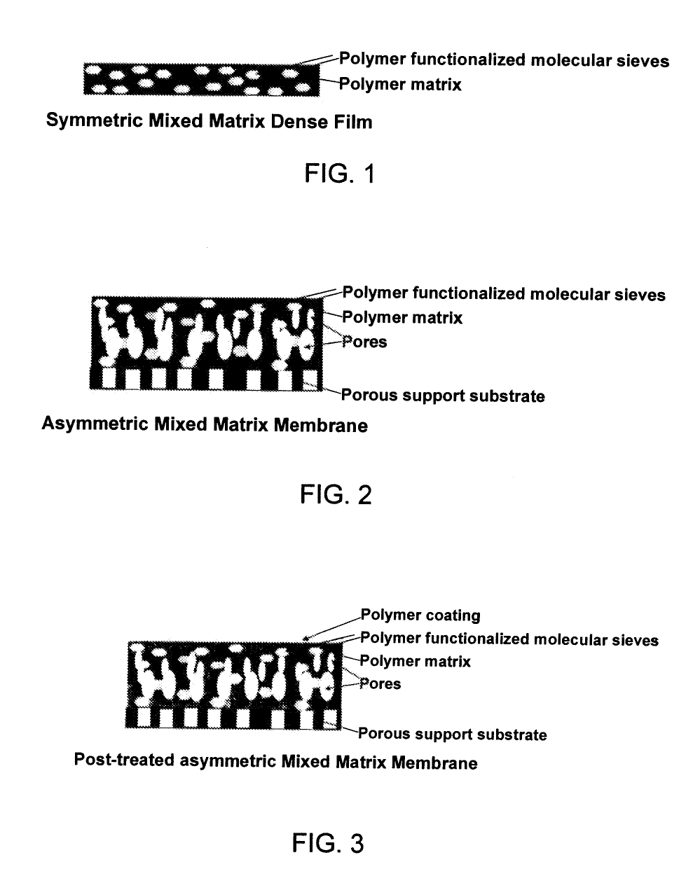

The present invention provides a method of making mixed matrix membranes (MMMs), particularly dense film MMMs, asymmetric flat sheet MMMs, or asymmetric hollow fiber MMMs, using stabilized concentrated suspensions containing dispersed polymer functionalized molecular sieve particles and a dissolved continuous polymer matrix in a mixture of organic solvents. The method comprises: (a) dispersing the molecular sieve particles in a mixture of two or more organic solvents by ultrasonic mixing and/or mechanical stirring or other method to form a molecular sieve slurry; (b) dissolving a suitable polymer in the molecular sieve slurry to functionalize the outer surface of the molecular sieve particles; (c) dissolving a polymer that serves as a continuous polymer matrix in the polymer functionalized molecular sieve slurry to form a stable polymer functionalized molecular sieve/polymer suspension; (d) fabricating an MMM in a form of symmetric dense film (FIG. 1), asymmetric flat sheet (FIG. 2), or asymmetric hollow fiber using the polymer functionalized molecular sieve/polymer suspension.

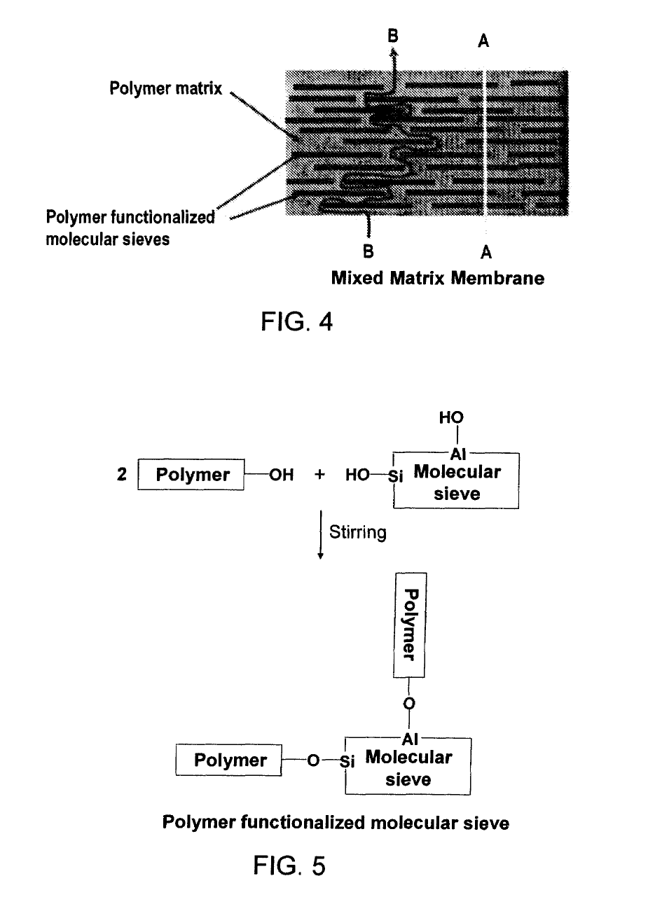

In some cases, a membrane post-treatment step can be added to improve selectivity that does not significantly change or damage the membrane, or cause the membrane to lose performance with time. The membrane post-treatment step can involve coating the top surface of the MMM with a thin layer of material such as a polysiloxane, a fluoro-polymer, a thermally curable silicone rubber, or a UV radiation curable epoxy silicone to fill the surface voids and defects on the MMM (FIG. 4).

Selection of the appropriate MMMs containing uniformly dispersed polymer functionalized molecular sieves described herein is based on the proper selection of components including selection of molecular sieves, the polymer used to functionalize the molecular sieves, the polymer served as the continuous polymer matrix, and the solvents used to dissolve the polymers.

The molecular sieves in the MMMs provided in this invention can have a selectivity that is significantly higher than the pure polymer membranes for separations. Addition of a small weight percent of the appropriate molecular sieves to the polymer matrix increases the overall separation efficiency significantly. The molecular sieves used in the MMMs of current invention include microporous and mesoporous molecular sieves, carbon molecular sieves, and porous metal-organic frameworks (MOFs).

Molecular sieves improve the performance of the MMM by including selective holes or pores having a diameter that permits a particular gas such as carbon dioxide to pass through, but either does not permit another gas such as methane to pass through, or permits it to pass through at a significantly slower rate resulting in a significant purification or separation to occur. In order to provide an advantage, the molecular sieves need to have higher selectivity for the desired separation than the original polymer to enhance the performance of the MMM. It is preferred that the steady-state permeability of the faster permeating gas component in the molecular sieves be at least equal to that of the faster permeating gas in the original polymer matrix phase.

Molecular sieves have framework structures which may be characterized by distinctive wide-angle X-ray diffraction patterns. Zeolites are a subclass of molecular sieves based on an aluminosilicate composition. Non-zeolitic molecular sieves are based on other compositions such as aluminophosphates, silico-aluminophosphates, and silica. Molecular sieves of different chemical compositions can have the same or different framework structures.

Zeolites can be further broadly described as molecular sieves in which complex aluminosilicate molecules assemble to define a three-dimensional framework structure enclosing cavities occupied by ions and water molecules which can move with significant freedom within the zeolite matrix. In commercially useful zeolites, the water molecules can be removed or replaced without destroying the framework structure. Zeolite compositions can be represented by the following formula: M_{2/n}O: Al₂O₃: xSiO₂: yH₂O, wherein M is a cation of valence n, x is greater than or equal to 2, and y is a number determined by the porosity and the hydration state of the zeolites, generally from 0 to 8. In naturally occurring zeolites, M is principally represented by Na, Ca, K, Mg and Ba in proportions usually reflecting their approximate geochemical abundance. The cations are loosely bound to the structure and can frequently be completely or partially replaced with other cations or hydrogen by conventional ion exchange. Acid forms of molecular sieve sorbents can be prepared by a variety of techniques including ammonium exchange followed by calcination or by direct exchange of alkali ions for protons using mineral acids or ion exchangers.

Microporous molecular sieve materials are microporous crystals with pores of a well-defined size ranging from about 0.2 to 2 nm. This discrete porosity provides molecular sieving properties to these materials which have found wide applications as catalysts and sorption media. Molecular sieve structure types can be identified by their structure type code as assigned by the IZA Structure Commission following the rules set up by the IUPAC Commission on Zeolite Nomenclature. Each unique framework topology is designated by a structure type code consisting of three capital letters. Exemplary compositions of such small pore alumina containing molecular sieves include non-zeolitic molecular sieves (NZMS) comprising certain aluminophosphates (AlPO's), silicoaluminophosphates (SAPO's), metallo-aluminophosphates (MeAPO's), elemental aluminophosphates (ElAPO's), metallo-silicoaluminophosphates (MeAPSO's) and elemental silicoaluminophosphates (ElAPSO's). Representative examples of microporous molecular sieves that can be used in the present invention are small pore molecular sieves such as SAPO-34, Si-DDR, UZM-9, AlPO-14, AlPO-34, AlPO-17, SSZ-62, AlPO-18, ERS-12, CDS-1, MCM-65, MCM-47, 4A, 5A, UZM-5, UZM-9, AlPO-34, SAPO-44, SAPO-47, SAPO-17, CVX-7, SAPO-35, SAPO-56, AlPO-52, SAPO-43, medium pore molecular sieves such as silicalite-1, and large pore molecular sieves such as NaX, NaY, and CaY.

Another type of molecular sieves used in the MMMs provided in this invention is mesoporous molecular sieves with pore size ranging from 2 nm to 50 nm. Examples of preferred mesoporous molecular sieves include MCM-41, SBA-15, and surface functionalized MCM-41 and SBA-15.

Metal-organic frameworks (MOFs) can also be used as the molecular sieves in the MMMs described in the present invention. MOFs are a new type of highly porous crystalline zeolite-like materials and are composed of rigid organic units assembled by metal-ligands. They possess vast accessible surface areas per unit mass. A number of journal articles discuss MOFs including the following: Yaghi et al., SCIENCE, 295: 469 (2002); Yaghi et al., MICROPOR. MESOPOR. MATER., 73: 3 (2004); Dybtsev et al., ANGEW. CHEM. INT. ED., 43: 5033 (2004).

MOF-5 is a prototype of a new class of porous materials constructed from octahedral Zn—O—C clusters and benzene links. Most recently, Yaghi et al. reported the systematic design and construction of a series of frameworks (IRMOF) that have structures based on the skeleton of MOF-5, wherein the pore functionality and size have been varied without changing the original cubic topology. For example, IRMOF-1 (Zn₄O(R₁-BDC)₃) has the same topology as that of MOF-5, but was synthesized by a simplified method. In 2001, Yaghi et al. reported the synthesis of a porous metal-organic polyhedron (MOP) Cu₂₄(m-BDC)₂₄(DMF)₁₄(H₂O)₅₀(DMF)₆(C₂H₅OH)₆, termed “α-MOP-1” and constructed from 12 paddle-wheel units bridged by m-BDC to give a large metal-carboxylate polyhedron. See Yaghi et al., J. Am. Chem. Soc., 123:4368 (2001). These MOF, IR-MOF and MOP materials exhibit analogous behaviour to that of conventional microporous materials such as large and accessible surface areas, with interconnected intrinsic micropores. Moreover, they may reduce the hydrocarbon fouling problem of polyimide membranes due to relatively larger pore sizes than those of zeolite materials. MOF, IR-MOF and MOP materials allow the polymer to infiltrate the pores, improve the interfacial and mechanical properties and would in turn affect permeability. Therefore, these MOF, IR-MOF and MOP materials (all termed “MOF” herein) are used as molecular sieves in the preparation of MMMs in the present invention.

The particle size of the molecular sieves dispersed in the continuous polymer matrix of the MMMs in the present invention should be small enough to form a uniform dispersion of the particles in the concentrated suspensions from which the MMMs will be fabricated. The median particle size should be less than about 10 μm, preferably less than 5 μm, and more preferably less than 1 μm. Most preferably, nano-molecular sieves (or “molecular sieve nanoparticles”) should be used in the MMMs of the current invention.

Nano-molecular sieves described herein are sub-micron size molecular sieves with particle sizes in the range of 5 to 1000 nm. Nano-molecular sieve selection for the preparation of MMMs includes screening the dispersity of the nano-molecular sieves in organic solvent, the porosity, particle size, morphology, and surface functionality of the nano-molecular sieves, the adhesion or wetting property of the nano-molecular sieves with the polymer matrix. Nano-molecular sieves for the preparation of MMMs should have suitable pore size to allow selective permeation of a smaller sized gas, and also should have appropriate particle size in the nanometer range to prevent defects in the membranes. The nano-molecular sieves should be easily dispersed without agglomeration in the polymer matrix to maximize the transport property.

The nano-molecular sieves described herein are usually synthesized from initially clear solutions. Representative examples of nano-molecular sieves suitable to be incorporated into the MMMs described herein include Si-MFI (or silicalite-1), SAPO-34, Si-DDR, AlPO-14, AlPO-34, AlPO-18, AlPO-17, AlPO-53, AlPO-52, SSZ-62, UZM-5, UZM-9, UZM-25, CDS-1, ERS-12, MCM-65 and mixtures thereof.

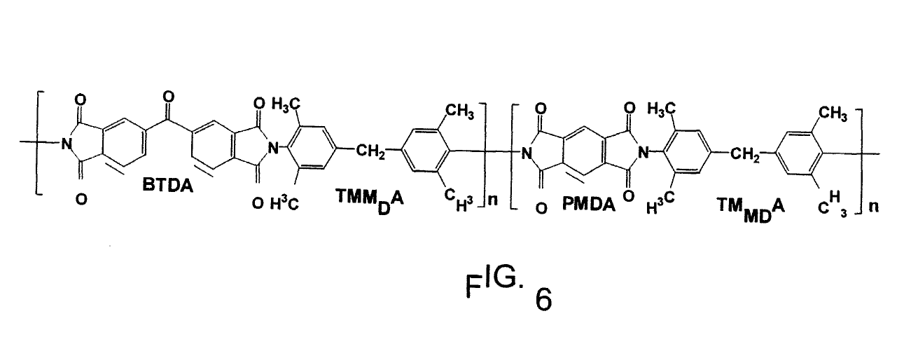

In the present invention, the molecular sieve particles dispersed in the concentrated suspension from which MMMs are formed are functionalized by a suitable polymer, which results in the formation of either polymer-O-molecular sieve covalent bonds via reactions between the hydroxyl (—OH) groups on the surfaces of the molecular sieves and the hydroxyl (—OH) groups at the polymer chain ends or at the polymer side chains of the molecular sieve stabilizers such as PES (FIG. 5) or hydrogen bonds between the hydroxyl groups on the surfaces of the molecular sieves and the functional groups such as ether groups on the polymer chains. The surfaces of the molecular sieves in the concentrated suspensions contain many hydroxyl groups attached to silicon (if present), aluminum (if present) and phosphate (if present). These hydroxyl groups on the molecular sieves in the concentrated suspensions can affect long-term stability of the suspensions and phase separation kinetics of the MMMs. The stability of the concentrated suspensions refers to the molecular sieve particles remaining homogeneously dispersed in the suspension. A key factor in determining whether aggregation of molecular sieve particles can be prevented and a stable suspension formed is the compatibility of these molecular sieve surfaces with the polymer matrix and the solvents in the suspensions. The functionalization of the outer surfaces of the molecular sieves using a suitable polymer provides good compatibility and an interface substantially free of voids and defects at the molecular sieve/polymer used to functionalize molecular sieves/polymer matrix interface. Therefore, voids and defects free polymer functionalized molecular sieve/polymer MMMs with significant separation property enhancements over traditional polymer membranes and over those prepared from suspensions containing the same polymer matrix and same molecular sieves but without polymer functionalization have been successfully prepared using these stable polymer functionalized molecular sieve/polymer suspensions. An absence of voids and defects at the interface increases the likelihood that the permeating species will be separated by passing through the pores of the molecular sieves in MMMs rather than passing unseparated through voids and defects. Therefore, the MMMs fabricated using the present invention combine the solution-diffusion mechanism of polymer membrane and the molecular sieving and sorption mechanism of molecular sieves (FIG. 4), and assure maximum selectivity and consistent performance among different membrane samples comprising the same molecular sieve/polymer composition.

The functions of the polymer used to functionalize the molecular sieve particles in the MMMs of the present invention include: 1) forming good adhesion between the molecular sieve and the polymer used to functionalize molecular sieves interface via hydrogen bonds or molecular sieve-O-polymer covalent bonds; 2) being an intermediate to improve the compatibility of the molecular sieves with the continuous polymer matrix; and 3) stabilizing the molecular sieve particles in the concentrated suspensions to remain homogeneously suspended. Any polymer that has these functions can be used to functionalize the molecular sieve particles in the concentrated suspensions from which MMMs are formed. Preferably, the polymers used to functionalize the molecular sieves contain functional groups such as amino groups that can form hydrogen bonding with the hydroxyl groups on the surfaces of the molecular sieves. More preferably, the polymers used to functionalize the molecular sieve contain functional groups such as hydroxyl or isocyanate groups that can react with the hydroxyl groups on the surface of the molecular sieves to form polymer-O-molecular sieve or polymer-NH—CO—O-molecular sieve covalent bonds. Thus, good adhesion between the molecular sieves and polymer is achieved. Representatives of such polymers are hydroxyl or amino group-terminated or ether polymers such as polyethersulfones (PESs), sulfonated PESs, polyethers such as hydroxyl group-terminated poly(ethylene oxide)s, amino group-terminated poly(ethylene oxide)s, or isocyanate group-terminated poly(ethylene oxide)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(allyl amine)s, poly(vinyl amine)s, as well as hydroxyl group-containing glassy polymers such as cellulosic polymers including cellulose acetate, cellulose triacetate, cellulose acetate-butyrate, cellulose propionate, ethyl cellulose, methyl cellulose, and nitrocellulose.

The weight ratio of the molecular sieves to the polymer used to functionalize these molecular sieves can be within a broad range, but not limited to, from about 1:2 to 100:1 based on the polymer used to functionalize the molecular sieves, i.e. 50 weight parts of molecular sieve per 100 weight parts of polymer used to functionalize the molecular sieves to about 100 weight parts of molecular sieve per 1 weight part of polymer used to functionalize the molecular sieves depending upon the properties sought as well as the dispersibility of a particular molecular sieves in a particular suspension. Preferably the weight ratio of the molecular sieves to the polymer used to functionalize the molecular sieves in the MMMs of the current invention is in the range from about 10:1 to 1:2.

The stabilized suspension contains polymer functionalized molecular sieve particles uniformly dispersed in the continuous polymer matrix. The MMM, particularly dense film MMM, asymmetric flat sheet MMM, or asymmetric hollow fiber MMM, is fabricated from the stabilized suspension. The MMM prepared by the present invention comprises uniformly dispersed polymer functionalized molecular sieve particles throughout the continuous polymer matrix. The polymer that serves as the continuous polymer matrix provides a wide range of properties important for separations, and modifying this polymer can improve membrane selectivity. A polymer with a high glass transition temperature (Tg), high melting point, and high crystallinity is preferred for most gas separations. Glassy polymers (i.e., polymers below their Tg) have stiffer polymer backbones and therefore allow smaller molecules such as hydrogen and helium to permeate the membrane quicker than larger molecules such as hydrocarbons. It is preferred that a membrane fabricated from the pure polymer, which can be used as the continuous polymer matrix in MMMs, exhibit a carbon dioxide or hydrogen over methane selectivity of at least 8, more preferably at least 15 at 50° C. under 690 kPa (100 psig) pure carbon dioxide or methane pressure about 20. Preferably, the polymer that serves as the continuous polymer matrix is a rigid, glassy polymer. The weight ratio of the molecular sieves to the polymer that serves as the continuous polymer matrix in the MMM of the current invention can be within a broad range from about 1:100 (1 weight part of molecular sieves per 100 weight parts of the polymer that serves as the continuous polymer matrix) to about 1:1 (100 weight parts of molecular sieves per 100 weight parts of the polymer that serves as the continuous polymer matrix) depending upon the properties sought as well as the dispersibility of the particular molecular sieves in the particular continuous polymer matrix.

The polymer that serves as the continuous polymer matrix in the MMM can be selected from, but is not limited to, polysulfones; sulfonated polysulfones; polyetherimides such as Ultem (or Ultem 1000) sold under the trademark Ultem®, manufactured by GE Plastics; cellulosic polymers, such as cellulose acetate and cellulose triacetate; polyamides; polyimides such as Matrimid sold under the trademark Matrimid® by Huntsman Advanced Materials (Matrimid® 5218 refers to a particular polyimide polymer sold under the trademark Matrimid®) and P84 or P84HT sold under the trade name P84 and P84HT respectively from HP Polymers GmbH; polyamide/imides; polyketones, polyether ketones; poly(arylene oxides) such as poly(phenylene oxide) and poly(xylene oxide); poly(esteramide-diisocyanate); polyurethanes; polyesters (including polyarylates), such as poly(ethylene terephthalate), poly(alkyl methacrylates), poly(acrylates), and poly(phenylene terephthalate); polysulfides; polymers from monomers having alpha-olefinic unsaturation in addition to those polymers previously listed including poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly (benzimidazole); polycarbodiimides; polyphosphazines; microporous polymers; and interpolymers, including block interpolymers containing repeating units from the above polymers such as interpolymers of acrylonitrile-vinyl bromide-sodium salt of para-sulfophenylmethallyl ethers; and grafts and blends containing any of the foregoing polymers. Typical substituents providing substituted polymers include halogens such as fluorine, chlorine and bromine; hydroxyl groups; lower alkyl groups; lower alkoxy groups; monocyclic aryl; and lower acryl groups.

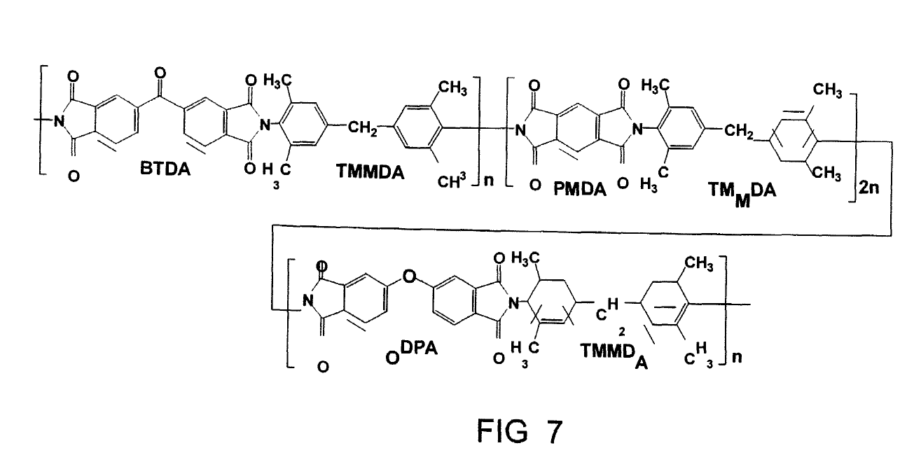

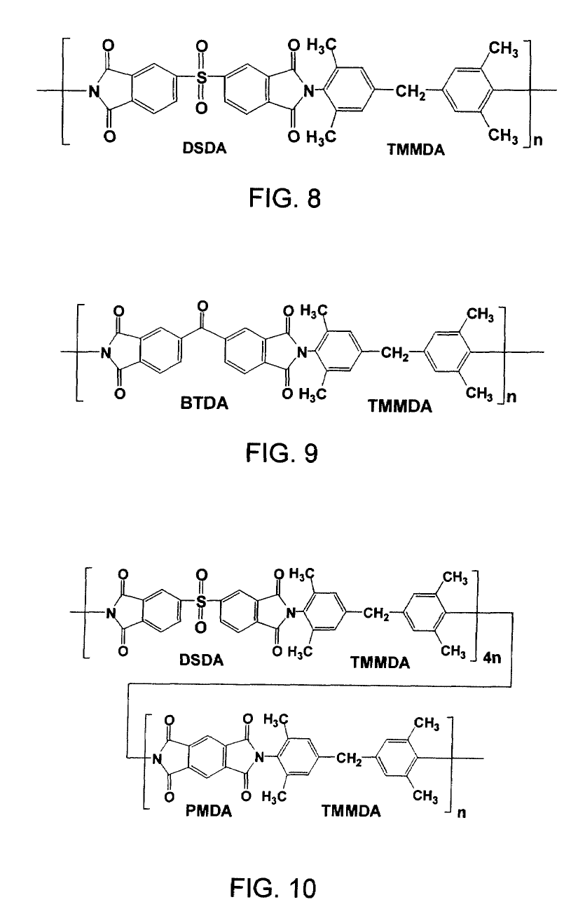

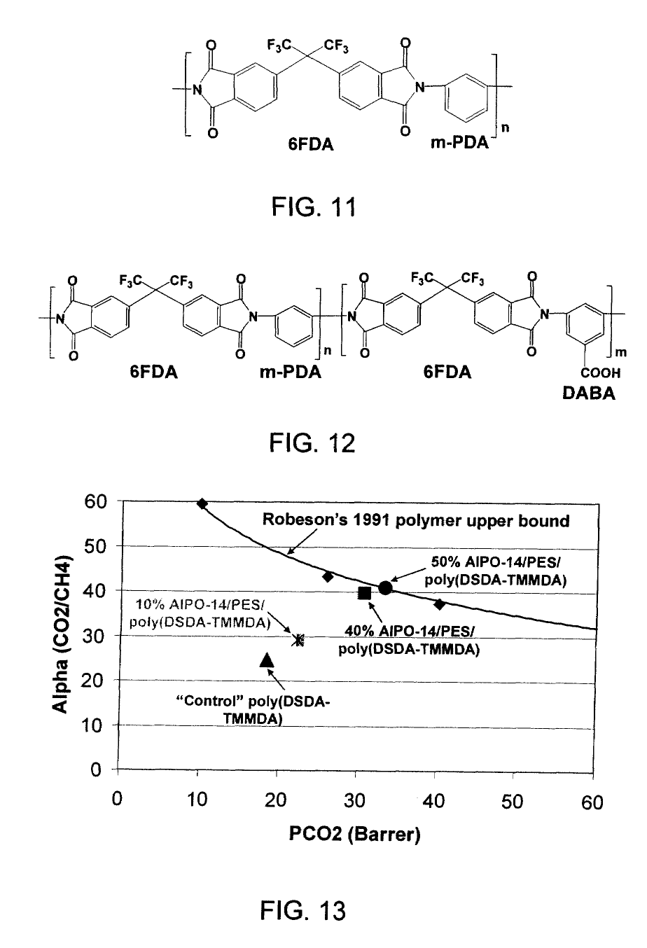

Some preferred polymers that can serve as the continuous polymer matrix include, but are not limited to, polysulfones, sulfonated polysulfones, polyetherimides such as Ultem (or Ultem 1000) sold under the trademark Ultem®, manufactured by GE Plastics, and available from GE Polymerland, cellulosic polymers such as cellulose acetate and cellulose triacetate, polyamides; polyimides such as Matrimid sold under the trademark Matrimid® by Huntsman Advanced Materials (Matrimid® 5218 refers to a particular polyimide polymer sold under the trademark Matrimid®), P84 or P84HT sold under the trade name P84 and P84HT respectively from HP Polymers GmbH, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA), FIG. 6), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA), FIG. 7), poly(3,3′,4,4′-diphenylsulfone tetracarboxylic dianhydride-3,3′,5,5′-tetramethyl-4,4′-methylene dianiline) (poly(DSDA-TMMDA), FIG. 8), poly(3,3′,4,4′-benzophenone tetracarboxylic dianhydride-3,3′,5,5′-tetramethyl-4,4′-methylene dianiline) (poly(BTDA-TMMDA), FIG. 9), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA), FIG. 10), poly[2,2′-bis-(3,4-dicarboxyphenyl)hexafluoropropane dianhydride-1,3-phenylenediamine] (poly(6FDA-m-PDA), FIG. 11), poly[2,2′-bis-(3,4-dicarboxyphenyl)hexafluoropropane dianhydride-1,3-phenylenediamine-3,5-diaminobenzoic acid)] (poly(6FDA-m-PDA-DABA), FIG. 12); polyamide/imides; polyketones, polyether ketones; and microporous polymers.

The most preferred polymers that can serve as the continuous polymer matrix include, but are not limited to, polyimides such as Matrimid®, P84®, poly(BTDA-PMDA-TMMDA), poly(BTDA-PMDA-ODPA-TMMDA), poly(DSDA-TMMDA), poly(BTDA-TMMDA), or poly(DSDA-PMDA-TMMDA), polyetherimides such as Ultem®, polysulfones, cellulose acetate, cellulose triacetate, and microporous polymers. Most preferably, the polymer that serves as the continuous polymer matrix is a polymer different from the polymer used to functionalize the molecular sieves.

Microporous polymers (or as so-called “polymers of intrinsic microporosity”) described herein are polymeric materials that possess microporosity intrinsic to their molecular structures. See McKeown, et al., CHEM. COMMUN., 2780 (2002); Budd, et al., ADV. MATER., 16:456 (2004); McKeown, et al., CHEM. EUR. J., 11:2610 (2005). This type of microporous polymer can be used as the continuous polymer matrix in MMMs in the current invention. The microporous polymers have a rigid rod-like, randomly contorted structure to generate intrinsic microporosity. These microporous polymers exhibit behavior analogous to that of conventional microporous molecular sieve materials, such as large and accessible surface areas, interconnected intrinsic micropores of less than 2 nm in size, as well as high chemical and thermal stability, but, in addition, possess properties of conventional polymers such as good solubility and easy processability. Moreover, these microporous polymers possess polyether polymer chains that have favorable interaction between carbon dioxide and the ethers.

The solvents used for dispersing the molecular sieve particles in the concentrated suspension and for dissolving the polymer used to functionalize the molecular sieves and the polymer that serves as the continuous polymer matrix are chosen primarily for their ability to completely dissolve the polymers and for ease of solvent removal in the membrane formation steps. Other considerations in the selection of solvents include low toxicity, low corrosive activity, low environmental hazard potential, availability and cost. Representative solvents for use in this invention include most amide solvents that are typically used for the formation of polymeric membranes, such as N-methylpyrrolidone (NMP) and N,N-dimethyl acetamide (DMAC), methylene chloride, THF, acetone, DMF, DMSO, toluene, dioxanes, 1,3-dioxolane, and mixtures thereof, as well as others known to those skilled in the art and mixtures thereof.

In the present invention, MMMs can be fabricated with various membrane structures such as mixed matrix dense films, asymmetric flat sheet MMMs, asymmetric thin film composite MMMs, or asymmetric hollow fiber MMMs from the stabilized concentrated suspensions containing a mixture of solvents, polymer functionalized molecular sieves, and a continuous polymer matrix. For example, the suspension can be sprayed, spin coated, poured into a sealed glass ring on top of a clean glass plate, or cast with a doctor knife. In another method, a porous substrate can be dip coated with the suspension.

One solvent removal technique that can be used is the evaporation of volatile solvents by ventilating the atmosphere above the forming membrane with a diluent dry gas and drawing a vacuum. Another solvent removal technique that can be used in making MMMs of the present invention calls for immersing the thin cast layer of the concentrated suspension (previously cast on a glass plate or on a porous or permeable substrate) in a non-solvent for the polymers but is miscible with the solvents in the suspension. To facilitate the removal of the solvents, the substrate and/or the atmosphere or non-solvent into which the thin layer of dispersion is immersed can be heated. When the MMM is substantially free of solvents, it can be detached from the glass plate to form a free-standing (or self-supporting) structure or the MMM can be left in contact with a porous or permeable support substrate to form an integral composite assembly.

Additional fabrication steps that can be used include washing the MMM in a bath of an appropriate liquid to extract residual solvents and other foreign substances from the membrane, drying the washed MMM to remove residual liquid, and in some cases coating a thin layer of material such as a polysiloxane, a fluoro-polymer, a thermally curable silicone rubber, or a UV radiation curable epoxy silicone to fill the surface voids and defects on the MMM.

One preferred embodiment of the current invention is in the form of an asymmetric flat sheet MMM for gas separation comprising a smooth thin dense selective layer on top of a highly porous supporting layer. In some cases of the preferred embodiment, the thin dense selective layer and the porous supporting layer are composed of the same polymer functionalized molecular sieve/polymer mixed matrix material. In some other cases of the preferred embodiment, the thin dense selective layer is composed of the polymer functionalized molecular sieve/polymer mixed matrix material and the porous supporting layer is composed of a pure polymer material. No major voids and defects on the top surface were observed. The back electron image (BEI) of the flat sheet asymmetric MMM showed that the polymer functionalized molecular sieve particles were uniformly distributed from the top dense layer to the porous support layer.

The method of the present invention for producing high performance MMMs is suitable for large scale membrane production and can be integrated into commercial polymer membrane manufacturing process. The MMMs, particularly dense film MMMs, asymmetric flat sheet MMMs, or asymmetric hollow fiber MMMs, fabricated by the method described in the current invention exhibit significantly enhanced selectivity and/or permeability over polymer membranes prepared from their corresponding polymer matrices and over those prepared from suspensions containing the same polymer matrix and same molecular sieves but without polymer functionalization.

The current invention provides a process for separating at least one gas from a mixture of gases using the MMMs described in the present invention, the process comprising: (a) providing an MMM comprising a polymer functionalized molecular sieve filler material uniformly dispersed in a continuous polymer matrix which is permeable to said at least one gas; (b) contacting the mixture on one side of the MMM to cause said at least one gas to permeate the MMM; and (c) removing from the opposite side of the membrane a permeate gas composition comprising a portion of said at least one gas which permeated said membrane.

The MMMs of the present invention are suitable for a variety of gas, vapor, and liquid separations, and particularly suitable for gas and vapor separations such as separations of CO₂/CH₄, H₂/CH₄, O₂/N₂, CO₂/N₂, olefin/paraffin, and iso/normal paraffins. These MMMs are especially useful in the purification, separation or adsorption of a particular species in the liquid or gas phase. In addition to separation of pairs of gases, these MMMs may, for example, be used for the separation of proteins or other thermally unstable compounds, e.g. in the pharmaceutical and biotechnology industries. The MMMs may also be used in fermenters and bioreactors to transport gases into the reaction vessel and transfer cell culture medium out of the vessel. Additionally, the MMMs may be used for the removal of microorganisms from air or water streams, water purification, ethanol production in a continuous fermentation/membrane pervaporation system, and in detection or removal of trace compounds or metal salts in air or water streams.

The MMMs are especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of CO₂ from natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the MMMs described herein. More than two gases can be removed from a third gas. For example, some of the gas components which can be selectively removed from a raw natural gas using the membrane described herein include carbon dioxide, oxygen, nitrogen, water vapor, hydrogen sulfide, helium, and other trace gases. Some of the gas components that can be selectively retained include hydrocarbon gases.

The MMMs described in the current invention are also especially useful in gas/vapor separation processes in chemical, petrochemical, pharmaceutical and allied industries for removing organic vapors from gas streams, e.g. in off-gas treatment for recovery of volatile organic compounds to meet clean air regulations, or within process streams in production plants so that valuable compounds (e.g., vinylchloride monomer, propylene) may be recovered. Further examples of gas/vapor separation processes in which these MMMs may be used are hydrocarbon vapor separation from hydrogen in oil and gas refineries, for hydrocarbon dew pointing of natural gas (i.e. to decrease the hydrocarbon dew point to below the lowest possible export pipeline temperature so that liquid hydrocarbons do not separate in the pipeline), for control of methane number in fuel gas for gas engines and gas turbines, and for gasoline recovery. The MMMs may incorporate a species that adsorbs strongly to certain gases (e.g. cobalt porphyrins or phthalocyanines for O₂ or silver(I) for ethane) to facilitate their transport across the membrane.

These MMMs may also be used in the separation of liquid mixtures by pervaporation, such as in the removal of organic compounds (e.g., alcohols, phenols, chlorinated hydrocarbons, pyridines, ketones) from water such as aqueous effluents or process fluids. A membrane which is ethanol-selective would be used to increase the ethanol concentration in relatively dilute ethanol solutions (5-10% ethanol) obtained by fermentation processes. Another liquid phase separation example using these MMMs is the deep desulphurization of gasoline and diesel fuels by a pervaporation membrane process similar to the process described in U.S. Pat. No. 7,048,846, incorporated by reference herein in its entirety. The MMMs that are selective to sulfur-containing molecules would be used to selectively remove sulfur-containing molecules from fluid catalytic cracking (FCC) and other naphtha hydrocarbon streams. Further liquid phase examples include the separation of one organic component from another organic component, e.g. to separate isomers of organic compounds. Mixtures of organic compounds which may be separated using an inventive membrane include: ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether,ethanol-ethylbutylether, propylacetate-propanol, isopropylether-isopropanol, methanol-ethanol-isopropanol, and ethylacetate-ethanol-acetic acid.

The MMMs may be used for separation of organic molecules from water (e.g. ethanol and/or phenol from water by pervaporation) and removal of metal and other organic compounds from water.

An additional application of the MMMs is in chemical reactors to enhance the yield of equilibrium-limited reactions by selective removal of a specific product in an analogous fashion to the use of hydrophilic membranes to enhance esterification yield by the removal of water.

The present invention pertains to novel voids and defects free polymer functionalized molecular sieve/polymer mixed matrix membranes (MMMs) fabricated from stable concentrated suspensions containing uniformly dispersed polymer functionalized molecular sieves and the continuous polymer matrix. These new MMMs have immediate application for the separation of gas mixtures including carbon dioxide removal from natural gas. A mixed matrix membrane permits carbon dioxide to diffuse through at a faster rate than the methane in the natural gas. Carbon dioxide has a higher permeation rate than methane because of higher solubility, higher diffusivity, or both. Thus, carbon dioxide enriches on the permeate side of the membrane, and methane enriches on the feed (or reject) side of the membrane.

Any given pair of gases that differ in size, for example, nitrogen and oxygen, carbon dioxide and methane, carbon dioxide and nitrogen, hydrogen and methane or carbon monoxide, helium and methane, can be separated using the MMMs described herein. More than two gases can be removed from a third gas. For example, some of the components which can be selectively removed from a raw natural gas using the membranes described herein include carbon dioxide, oxygen, nitrogen, water vapor, hydrogen sulfide, helium, and other trace gases. Some of the components that can be selectively retained include hydrocarbon gases.

### EXAMPLES

The following examples are provided to illustrate one or more preferred embodiments of the invention, but are not limited embodiments thereof. Numerous variations can be made to the following examples that lie within the scope of the invention.

### Example 1

### Preparation of “Control” poly(DSDA-TMMDA) Polymer Dense Film

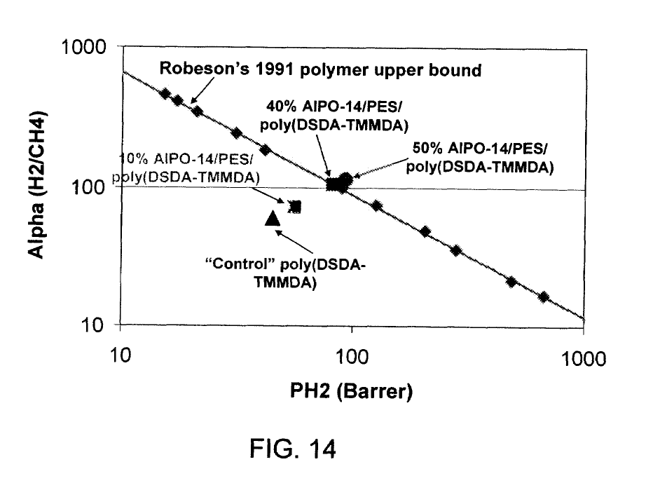

7.2 g of poly(DSDA-TMMDA) polyimide polymer (FIG. 8) and 0.8 g of polyethersulfone (PES) were dissolved in a solvent mixture of 14.0 g of NMP and 20.6 g of 1,3-dioxolane. The mixture was mechanically stirred for 3 hours to form a homogeneous casting dope. The resulting homogeneous casting dope was allowed to degas overnight. A “control” poly(DSDA-TMMDA) polymer dense film was prepared from the bubble free casting dope on a clean glass plate using a doctor knife with a 20-mil gap. The dense film together with the glass plate was then put into a vacuum oven. The solvents were removed by slowly increasing the vacuum and the temperature of the vacuum oven. Finally, the dense film was dried at 200° C. under vacuum for at least 48 hours to completely remove the residual solvents to form the “control” poly(DSDA-TMMDA) polymer dense film (abbreviated as “control” poly(DSDA-TMMDA) in Tables 1 and 2, and FIGS. 13 and 14).

### Example 2

### Preparation of 10% AlPO-14/PES/poly(DSDA-TMMDA) Mixed Matrix Dense Film

A polyethersulfone (PES) functionalized AlPO-14/poly(DSDA-TMMDA) mixed matrix dense film containing 10 wt-% of dispersed AlPO-14 molecular sieve fillers in a poly(DSDA-TMMDA) polyimide continuous matrix (10% AlPO-14/PES/poly(DSDA-TMMDA)) was prepared as follows:

0.8 g of AlPO-14 molecular sieves were dispersed in a mixture of 14.0 g of NMP and 20.6 g of 1,3-dioxolane by mechanical stirring and ultrasonication for 1 hour to form a slurry. Then 0.8 g of PES was added to functionalize AlPO-14 molecular sieves in the slurry. The slurry was stirred for at least 1 hour to completely dissolve the PES polymer and to functionalize the outer surface of the AlPO-14 molecular sieve. After that, 7.2 g of poly(DSDA-TMMDA) polyimide polymer was added to the slurry and the resulting mixture was stirred for another 2 hour to form a stable casting dope containing 10 wt-% of dispersed PES functionalized AlPO-14 molecular sieves (weight ratio of AlPO-14 to poly(DSDA-TMMDA) and PES is 10:100; weight ratio of PES to poly(DSDA-TMMDA) is 1:9) in the continuous poly(DSDA-TMMDA) polymer matrix. The stable casting dope was allowed to degas overnight.

A 10% AlPO-14/PES/poly(DSDA-TMMDA) mixed matrix dense film was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the dense film was dried at 200° C. under vacuum for at least 48 hours to completely remove the residual solvents to form 10% AlPO-14/PES/poly(DSDA-TMMDA) mixed matrix dense film (abbreviated as 10% AlPO-14/PES/poly(DSDA-TMMDA) in Tables 1 and 2, and FIGS. 13 and 14).

### Example 3

### Preparation of 40% AlPO-14/PES/poly(DSDA-TMMDA) Mixed Matrix Dense Film

A 40% AlPO-14/PES/poly(DSDA-TMMDA) mixed matrix dense film (abbreviated as 40% AlPO-14/PES/poly(DSDA-TMMDA) in Tables 1 and 2, and FIGS. 13 and 14) was prepared using similar procedures as described in Example 2, but the weight ratio of AlPO-14 to poly(DSDA-TMMDA) and PES is 40:100.

### Example 4

### Preparation of 50% AlPO-14/PES/poly(DSDA-TMMDA) Mixed Matrix Dense Film

A 50% AlPO-14/PES/poly(DSDA-TMMDA) mixed matrix dense film (abbreviated as 50% AlPO-14/PES/poly(DSDA-TMMDA) in Tables 1 and 2, and FIGS. 13 and 14) was prepared using similar procedures as described in Example 2, but the weight ratio of AlPO-14 to poly(DSDA-TMMDA) and PES is 50:100.

### Example 5

### Preparation of “Comparative” 50% AlPO-14/poly(DSDA-TMMDA) Mixed Matrix Dense Film

A “comparative” 50% AlPO-14/poly(DSDA-TMMDA) mixed matrix dense film containing 50 wt-% of dispersed AlPO-14 molecular sieve fillers without surface functionalization by PES in a poly(DSDA-TMMDA) polyimide continuous matrix (“comparative” 50% AlPO-14/poly(DSDA-TMMDA)) was prepared as follows:

4.0 g of AlPO-14 molecular sieves were dispersed in a mixture of 14.0 g of NMP and 20.6 g of 1,3-dioxolane by mechanical stirring and ultrasonication for 1 hour to form a slurry. After that, 8.0 g of poly(DSDA-TMMDA) polyimide polymer was added to the slurry and the resulting mixture was stirred for another 2 hour to form a casting dope containing 50 wt-% of AlPO-14 molecular sieves (weight ratio of AlPO-14 to poly(DSDA-TMMDA) is 50:100) in the continuous poly(DSDA-TMMDA) polymer matrix. The casting dope was allowed to degas overnight.

The “comparative” 50% AlPO-14/poly(DSDA-TMMDA) mixed matrix dense film was prepared on a clean glass plate from the bubble free casting dope using a doctor knife with a 20-mil gap. The film together with the glass plate was then put into a vacuum oven. The solvents were removed by slowly increasing the vacuum and the temperature of the vacuum oven. Finally, the dense film was dried at 200° C. under vacuum for at least 48 hours to completely remove the residual solvents to form the mixed matrix dense film (abbreviated as “comparative” 50% AlPO-14/poly(DSDA-TMMDA) in Tables 1 and 2).

### Example 6

### CO₂/CH₄ Separation Properties of “Control” poly(DSDA-TMMDA) Polymer Dense Film, “Comparative” 50% AlPO-14/poly(DSDA-TMMDA), and AlPO-14/PES/poly(DSDA-TMMDA) Mixed Matrix Dense Films

The permeabilities (P_{CO2} and PCH₄) and selectivity (α_{CO2/CH4}) of the “control” poly(DSDA-TMMDA) polymer dense film prepared in Example 1, AlPO-14/PES/poly(DSDA-TMMDA) mixed matrix dense films containing a continuous poly(DSDA-TMMDA) polyimide matrix and PES functionalized AlPO-14 fillers (poly(DSDA-TMMDA)/PES=9:1, All PES was used to functionalize AlPO-14, AlPO-14/(poly(DSDA-TMMDA)+PES)=0.1, 0.4, and 0.5, respectively) prepared in Examples 2 to 4, and the “comparative” 50% AlPO-14/poly(DSDA-TMMDA) mixed matrix dense film prepared in Example 5 were measured by pure gas measurements at 50° C. under about 690 kPa (100 psig) pressure using a dense film test unit. The results for CO₂/CH₄ separation are shown in Table 1 and FIG. 13.

The pure gas permeation testing results in Table 1 showed that α_{CO2/CH4} of the “comparative” 50% AlPO-14/poly(DSDA-TMMDA) mixed matrix dense film incorporating AlPO-14 molecular sieve particles without surface functionalization by PES polymer decreased 47% compared to that of the “control” poly(DSDA-TMMDA) polymer dense film. This result indicates that there are voids and defects between AlPO-14 molecular sieve particles and poly(DSDA-TMMDA) polymer matrix. However, it can be seen from Table 1 and FIG. 13 that the AlPO-14/PES/poly(DSDA-TMMDA) mixed matrix dense films incorporating PES functionalized AlPO-14 molecular sieves showed a consistent increase in both α_{CO2/CH4} and P_{CO2} for CO₂/CH₄ separation when AlPO-14 loading increased from 0 (“control” poly(DSDA-TMMDA) dense film) to 0.5 (50% AlPO-14/PES/poly(DSDA-TMMDA)), demonstrating a successful combination of molecular sieving mechanism of AlPO-14 molecular sieve fillers with the solution-diffusion mechanism of poly(DSDA-TMMDA) polyimide matrix in these MMMs for CO₂/CH₄ gas separation. For example, 10% AlPO-14/PES/poly(DSDA-TMMDA) MMM showed simultaneous α_{CO2/CH4} increase by 18% and P_{CO2} increase by 21% compared to the “control” poly(DSDA-TMMDA) dense film for CO₂/CH₄ separation. For another example, 50% AlPO-14/PES/poly(DSDA-TMMDA) MMM showed simultaneous α_{CO2/CH4} increase by 65% and P_{CO2} increase by 80% compared to the “control” poly(DSDA-TMMDA) dense film for CO₂/CH₄ separation. These results suggest that functionalization of molecular sieve surface using PES is an effective method to improve the compatibility at the molecular sieve/polyimide interface of the MMMs.

FIG. 13 shows CO₂/CH₄ separation performance of “control” poly(DSDA-TMMDA) and AlPO-14/PES/poly(DSDA-TMMDA) mixed matrix dense films incorporating PES functionalized AlPO-14 molecular sieves at 50° C. and 690 kPa (100 psig), as well as Robeson's 1991 polymer upper limit data for CO₂/CH₄ separation at 35° C. and about 345 kPa (50 psig) from literature (see Robeson, J. MEMBR. SCI., 62: 165 (1991))). It can be seen that the CO₂/CH₄ separation performance of the “control” poly(DSDA-TMMDA) dense film is far below Robeson's 1991 polymer upper bound for CO₂/CH₄ separation. When 50 wt-% of AlPO-14 molecular sieve fillers were functionalized by PES polymer and incorporated into the “control” poly(DSDA-TMMDA) polymer matrix, the resulting 50% AlPO-14/PES/poly(DSDA-TMMDA) MMM showed significantly enhanced CO₂/CH₄ separation performance, which reaches Robeson's 1991 polymer upper bound for CO₂/CH₄ separation. These results indicate that the novel voids and defects free PES functionalized AlPO-14/PES/poly(DSDA-TMMDA) MMMs are very promising membrane candidates for the removal of CO₂ from natural gas or flue gas. The improved performance of AlPO-14/PES/poly(DSDA-TMMDA) MMMs over the “control” poly(DSDA-TMMDA) and the “comparative” 50% AlPO-14/poly(DSDA-TMMDA) MMM is attributed to the successful combination of molecular sieving mechanism of AlPO-14 molecular sieve fillers with the solution-diffusion mechanism of poly(DSDA-TMMDA) polyimide matrix in these MMMs.

TABLE 1
Pure gas permeation test results of “Control” poly(DSDA-TMMDA) polymer
dense film, “comparative” 50% AlPO-14/poly(DSDA-TMMDA), and
AlPO-14/PES/poly(DSDA-TMMDA) mixed matrix dense films for
CO₂/CH₄ separation^{a}

| | P_{CO2} | ΔP_{CO2} | | |
|---|---|---|---|---|
| Dense film | (Barrer) | (Barrer) | α_{CO2/CH4} | Δα_{CO2/CH4} |
| “Control” poly(DSDA-TMMDA) | 18.5 | 0 | 24.8 | 0 |
| 10% AlPO-14/PES/poly(DSDA-TMMDA) | 22.3 | 21% | 29.2 | 18% |
| 40% AlPO-14/PES/poly(DSDA-TMMDA) | 30.7 | 66% | 39.6 | 60% |
| 50% AlPO-14/PES/poly(DSDA-TMMDA) | 33.3 | 80% | 40.9 | 65% |
| “Comparative” 50% AlPO-14/poly(DSDA- | 61.6 | 233% | 13.2 | −47% |
| TMMDA) | | | | |

^{a}Tested at 50° C. under 690 kPa (100 psig) pure gas pressure; 1 Barrer = 10⁻¹⁰ (cm³(STP) · cm)/(cm² · sec · cmHg)

### Example 7

### H₂/CH₄ Separation Properties of “Control” poly(DSDA-TMMDA) Polymer Dense Film, “Comparative” 50% AlPO-14/poly(DSDA-TMMDA), and AlPO-14/PES/poly(DSDA-TMMDA) Mixed Matrix Dense Films

The permeabilities (P_{H2} and P_{CH4}) and selectivity (α_{H2/CH4}) of the “control” poly(DSDA-TMMDA) polymer dense film prepared in Example 1, AlPO-14/PES/poly(DSDA-TMMDA) mixed matrix dense films containing a continuous poly(DSDA-TMMDA) polyimide matrix and PES functionalized AlPO-14 fillers (poly(DSDA-TMMDA)/PES=9:1, All PES was used to functionalize AlPO-14, AlPO-14/(poly(DSDA-TMMDA)+PES)=0.1, 0.4, and 0.5, respectively) prepared in Examples 2 to 4, and “comparative” 50% AlPO-14/poly(DSDA-TMMDA) prepared in Example 5 were measured by pure gas measurements at 50° C. under about 690 kPa (100 psig) pressure using a dense film test unit. The results for H₂/CH₄ separation are shown in Table 2 and FIG. 14.

The pure gas permeation testing results in Table 2 showed that α_{H2/CH4} of the “comparative” 50% AlPO-14/poly(DSDA-TMMDA) mixed matrix dense film incorporating AlPO-14 molecular sieve particles without surface functionalization by PES polymer decreased 48% compared to that of the “control” poly(DSDA-TMMDA) polymer dense film. This result indicates that there are voids and defects between AlPO-14 molecular sieve particles and poly(DSDA-TMMDA) polymer matrix. However, it can be seen from Table 2 and FIG. 14 that the AlPO-14/PES/poly(DSDA-TMMDA) mixed matrix dense films incorporating PES functionalized AlPO-14 molecular sieves showed consistent increase in both selectivity and permeability for H₂/CH₄ separation when AlPO-14 loading increased from 0 (“control” poly(DSDA-TMMDA) dense film) to 0.5 (50% AlPO-14/PES/poly(DSDA-TMMDA)), demonstrating the successful combination of molecular sieving mechanism of AlPO-14 molecular sieve fillers with the solution-diffusion mechanism of poly(DSDA-TMMDA) polyimide matrix in these MMMs for H₂/CH₄ gas separation. For example, 10% AlPO-14/PES/poly(DSDA-TMMDA) MMM exhibited simultaneous α_{H2/CH4} increase by 20% and P_{H2} increase by 22% compared to the “control” poly(DSDA-TMMDA) dense film for H₂/CH₄ separation. For another example, 40% AlPO-14/PES/poly(DSDA-TMMDA) MMM showed simultaneous α_{H2/CH4} increase by 75% and P_{H2} increase by 82% compared to the “control” poly(DSDA-TMMDA) dense film for H₂/CH₄ separation. These results suggest that functionalization of molecular sieve surface using PES is an effective method to improve the compatibility at the molecular sieve/polyimide interface of the MMMs.

FIG. 14 shows H₂/CH₄ separation performance of “control” poly(DSDA-TMMDA) and AlPO-14/PES/poly(DSDA-TMMDA) mixed matrix dense films incorporating PES functionalized AlPO-14 with different loadings of the present invention at 50° C. and 690 kPa (100 psig), as well as Robeson's 1991 polymer upper limit data for H₂/CH₄ separation at 35° C. and about 345 kPa (50 psig) from literature (see Robeson, J. MEMBR. SCI., 62: 165 (1991))). It can be seen that H₂/CH₄ separation performance of the “control” poly(DSDA-TMMDA) dense film is far below Robeson's 1991 polymer upper bound for H₂/CH₄ separation. Compared to this “control” dense film, the H₂/CH₄ separation performance of 40% AlPO-14/PES/poly(DSDA-TMMDA) MMM incorporating 40 wt-% of AlPO-14 fillers into poly(DSDA-TMMDA) matrix was greatly improved and reached Robeson's 1991 polymer upper bound for H₂/CH₄ separation. The H₂/CH₄ separation performance of 50% AlPO-14/PES/poly(DSDA-TMMDA) MMM was further improved compared to that of 40% AlPO-14/PES/poly(DSDA-TMMDA) MMM and exceeded Robeson's 1991 polymer upper bound for H₂/CH₄ separation. These results indicate that the novel voids and defects free PES functionalized AlPO-14/PES/poly(DSDA-TMMDA) MMMs are very promising membrane candidates for the removal of H₂ from natural gas. The improved performance of AlPO-14/PES/poly(DSDA-TMMDA) MMMs over the “control” poly(DSDA-TMMDA) and the “comparative” 50% AlPO-14/poly(DSDA-TMMDA) MMM is attributed to the successful combination of molecular sieving mechanism of AlPO-14 molecular sieve fillers with the solution-diffusion mechanism of poly(DSDA-TMMDA) polyimide matrix in these MMMs.

TABLE 2
Pure gas permeation test results of “Control” poly(DSDA-TMMDA) polymer
dense film, “comparative” 50% AlPO-14/poly(DSDA-TMMDA), and
AlPO-14/PES/poly(DSDA-TMMDA) mixed matrix dense films
for H₂/CH₄ separation^{a}

| | | ΔP_{H2} | | |
|---|---|---|---|---|
| Dense film | P_{H2} (Barrer) | (Barrer) | α_{H2/CH4} | Δα_{H2/CH4} |
| “Control” poly(DSDA-TMMDA) | 44.8 | 0 | 60.1 | 0 |
| 10% AlPO-14/PES/poly(DSDA-TMMDA) | 55.3 | 23% | 72.3 | 20% |
| 40% AlPO-14/PES/poly(DSDA-TMMDA) | 81.6 | 82% | 105.3 | 75% |
| 50% AlPO-14/PES/poly(DSDA-TMMDA) | 92.0 | 105% | 113.1 | 88% |
| “Comparative” 50% AlPO-14/poly(DSDA- | 146.7 | 227% | 31.3 | −48% |
| TMMDA) | | | | |

^{a}Tested at 50° C. under 690 kPa (100 psig) pure gas pressure; 1 Barrer = 10⁻¹⁰ (cm³(STP) · cm)/(cm² · sec · cmHg)

### Example 8

### Preparation of “Control” poly(DSDA-TMMDA) Flat Sheet Asymmetric Polymer Membrane

7.2 g of poly(DSDA-TMMDA) polyimide polymer and 0.8 g of polyethersulfone (PES) were dissolved in a solvent mixture of 14.0 g of NMP and 20.6 g of 1,3-dioxolane by mechanical stirring for 1 hour. Then a mixture of 4.0 g of acetone, 4.0 g of isopropanol, and 0.8 g of octane was added to the polymer solution. The mixture was mechanically stirred for another 3 hours to form a homogeneous casting dope. The resulting homogeneous casting dope was allowed to degas overnight.

A poly(DSDA-TMMDA) film was cast on a non-woven fabric substrate from the bubble free casting dope using a doctor knife with a 10-mil gap. The film together with the fabric substrate was gelled by immersing in a DI water bath at 0° to 5° C. for 10 minutes, and then immersed in a DI water bath at 50° C. for another 10 minutes to remove the residual solvents and the water. The resulting wet “control” poly(DSDA-TMMDA) flat sheet asymmetric polymer membrane was dried at about 70° to 80° C. in an oven to completely remove the solvents and the water. The dry “control” poly(DSDA-TMMDA) flat sheet asymmetric polymer membrane was then coated with a thermally curable silicon rubber solution (RTV615A+B Silicon Rubber from GE Silicons containing 27 wt-% RTV615A and 3 wt-% RTV615B catalyst and 70 wt-% cyclohexane solvent). The RTV615A+B coated membrane was cured at 85° C. for at least 2 hours in an oven to form the final “control” poly(DSDA-TMMDA) flat sheet asymmetric polymer membrane (abbreviated as Asymmetric “control” poly(DSDA-TMMDA) in Table 3).

### Example 9

### Preparation of 30% AlPO-18/PES/poly(DSDA-TMMDA) Flat Sheet Asymmetric MMM

2.4 g of AlPO-18 molecular sieves were dispersed in a mixture of 14.0 g of NMP and 20.6 g of 1,3-dioxolane by mechanical stirring and ultrasonication for 1 hour to form a slurry. Then 0.8 g of PES was added to functionalize the AlPO-18 molecular sieves in the slurry. The slurry was stirred for at least 1 hour to completely dissolve the PES polymer and functionalize the surface of AlPO-18. After that, 7.2 g of poly(DSDA-TMMDA) polyimide polymer was added to the slurry and the resulting mixture was stirred for another 1 hour. Then a mixture of 4.0 g of acetone, 4.0 g of isopropanol, and 0.8 g of octane was added and the mixture was mechanically stirred for another 2 h to form a stable casting dope containing 30 wt-% of dispersed PES functionalized AlPO-18 molecular sieves (weight ratio of AlPO-18 to poly(DSDA-TMMDA) and PES is 30:100; weight ratio of PES to poly(DSDA-TMMDA) is 1:9) in the continuous poly(DSDA-TMMDA) polymer matrix. The stable casting dope was allowed to degas overnight.

A 30% AlPO-18/PES/poly(DSDA-TMMDA) film was cast on a non-woven fabric substrate from the bubble free casting dope using a doctor knife with a 10-mil gap. The film together with the fabric substrate was gelled by immersing in a DI water bath at 0° to 5° C. for 10 minutes, and then immersed in a DI water bath at 50° C. for another 10 minutes to remove the residual solvents and the water. The resulting wet 30% AlPO-18/PES/poly(DSDA-TMMDA) flat sheet asymmetric MMM was dried at between 70° and 80° C. in an oven to completely remove the solvents and the water. The dry 30% AlPO-18/PES/poly(DSDA-TMMDA) flat sheet asymmetric MMM was then coated with a thermally curable silicon rubber solution (RTV615A+B Silicon Rubber from GE Silicons) containing 27 wt-% RTV615A and 3 wt-% RTV615B catalyst and 70 wt-% cyclohexane solvent). The RTV615A+B coated membrane was cured at 85° C. for at least 2 hours in an oven to form the final 30% AlPO-18/PES/poly(DSDA-TMMDA) flat sheet asymmetric MMM (abbreviated as Asymmetric 30% AlPO-18/PES/poly(DSDA-TMMDA) in Table 3).

### Example 10

### Preparation of “Comparative” 30% AlPO-18/poly(DSDA-TMMDA) Flat Sheet Asymmetric MMM

The “comparative” 30% AlPO-18/poly(DSDA-TMMDA) flat sheet asymmetric MMM (abbreviated as Asymmetric “comparative” 30% AlPO-18/poly(DSDA-TMMDA) in Table 3) was prepared using similar procedures as described in Example 9, but the surface of the AlPO-14 molecular sieve was not functionalized by PES polymer.

### Example 111

### Permeation Properties of the “Control” poly(DSDA-TMMDA) Flat Sheet Asymmetric Polymer Membrane, “Comparative” 30% AlPO-18/poly(DSDA-TMMDA) Flat Sheet Asymmetric MMM, and 30% AlPO-18/PES/poly(DSDA-TMMDA) Flat Sheet Asymmetric MMM

To improve the compatibility at the molecular sieve/polyimide interface of the asymmetric MMMs, the surface of the molecular sieve fillers was functionalized by PES polymer via covalent bonds. 30% AlPO-18/PES/poly(DSDA-TMMDA) asymmetric MMM containing poly(DSDA-TMMDA) polyimide matrix and PES functionalized AlPO-18 fillers (poly(DSDA-TMMDA)/PES=9:1, All PES was used to functionalize AlPO-18, AlPO-18/(poly(DSDA-TMMDA)+PES)=0.3) was prepared in Example 9. For comparison purposes, a “control” poly(DSDA-TMMDA) asymmetric polymer membrane and a “comparative” 30% AlPO-18/poly(DSDA-TMMDA) asymmetric MMM in which the AlPO-18 molecular sieve fillers were not functionalized by PES polymer were also prepared in Examples 8 and 10, respectively.

The CO₂ and CH₄ permeabilities and CO₂/CH₄ selectivities of these membranes were determined from pure gas measurements under 690 kPa (100 psig) pure gas pressure at 25° C. and 50° C., respectively, using asymmetric membrane test equipment. Table 3 summarizes the testing results. It can be seen from Table 3 that the 30% AlPO-18/PES/poly(DSDA-TMMDA) flat sheet asymmetric MMM in which the AlPO-18 molecular sieve fillers were functionalized by PES polymer exhibited>100% increase in CO₂ flux (P_{CO2}/l) without loss in α_{CO2/CH4} compared to the “control” poly(DSDA-TMMDA) flat sheet asymmetric polymer membrane under 690 kPa (100 psig) pure gas pressure at both 25° and 50° C. However, the “comparative” 30% AlPO-18/poly(DSDA-TMMDA) asymmetric MMM in which the AlPO-18 molecular sieve fillers were not functionalized by PES polymer showed α_{CO2/CH4}<5, indicating the existence of major voids and defects in this membrane. These results demonstrated that functionalization of molecular sieve surface using PES is an effective method to improve the compatibility at the molecular sieve/polyimide interface, resulting in voids and defect free asymmetric molecular sieve/polymer mixed matrix membranes.

TABLE 3
Pure gas permeation test results of “Control” poly(DSDA-TMMDA)
flat sheet asymmetric polymer membrane and 30%
AlPO-18/PES/poly(DSDA-TMMDA) flat sheet asymmetric
mixed matrix membrane for CO₂/CH₄ separation

| | P_{CO2}/l | ΔP_{CO2}/l | |
|---|---|---|---|
| Membrane | (A.U.)^{c} | (A.U.)^{c} | α_{CO2/CH4} |
| Asymmetric “Control” | 13.9 | 0 | 28.4 |
| poly(DSDA-TMMDA)^{a} | | | |
| Asymmetric “comparative” 30% AlPO- | 2.90 | −79% | 3.74 |
| 18/poly(DSDA-TMMDA)^{a} | | | |
| Asymmetric 30% AlPO- | 29.2 | 110% | 31.1 |
| 18/PES/poly(DSDA-TMMDA)^{a} | | | |
| Asymmetric “Control” | 10.2 | 0 | 23.2 |
| poly(DSDA-TMMDA)^{b} | | | |
| Asymmetric 30% AlPO- | 23.9 | 134% | 21.5 |
| 18/PES/poly(DSDA-TMMDA)^{b} | | | |

^{a}Tested at 25° C. under 690 kPa (100 psig) pure gas pressure.
^{b}Tested at 50° C. under 690 kPa (100 psig) pure gas pressure.
^{c}1 A.U. = 1 ft³ (STP)/h · ft² · 690 kPa (100 psig).

### Example 12

### Preparation of “Control” poly(BTDA-PMDA-ODPA-TMMDA) Polymer Dense Film

A “control” poly(BTDA-PMDA-ODPA-TMMDA) polymer dense film (abbreviated as “control” poly(BTDA-PMDA-ODPA-TMMDA) in Tables 4 and 5) was prepared using similar procedures as described in Example 1, but replacing poly(DSDA-TMMDA) by poly(BTDA-PMDA-ODPA-TMMDA).

### Example 13

### Preparation of 30% AlPO-14/PES/poly(BTDA-PMDA-ODPA-TMMDA) Mixed Matrix Dense Film

30% AlPO-14/PES/poly(BTDA-PMDA-ODPA-TMMDA) mixed matrix dense film incorporating PES functionalized AlPO-14 molecular sieves (abbreviated as 30% AlPO-14/PES/poly(BTDA-PMDA-ODPA-TMMDA) in Tables 4 and 5) was prepared using similar procedures as described in Example 2, but replacing poly(DSDA-TMMDA) by poly(BTDA-PMDA-ODPA-TMMDA) and the weight ratio of AlPO-14 to poly(BTDA-PMDA-ODPA-TMMDA) and PES is 30:100.

### Example 14

### CO₂/CH₄ Separation Properties of “Control” poly(BTDA-PMDA-ODPA-TMMDA) Polymer Dense Film and 30% AlPO-14/PES/poly(BTDA-PMDA-ODPA-TMMDA) Mixed Matrix Dense Film

The permeabilities (P_{CO2} and P_{CH4}) and selectivity (α_{CO2/CH4}) of the “control” poly(BTDA-PMDA-ODPA-TMMDA) polymer dense film prepared in Example 12 and 30% AlPO-14/PES/poly(BTDA-PMDA-ODPA-TMMDA) mixed matrix dense film containing PES functionalized AlPO-14 fillers prepared in Example 13 were measured by pure gas measurements at 50° C. under about 690 kPa (100 psig) pressure using a dense film test unit. The results for CO₂/CH₄ separation are shown in Table 4.

It can be seen from Table 4 that the 30% AlPO-14/PES/poly(BTDA-PMDA-ODPA-TMMDA) MMM showed significant simultaneous increase in both α_{CO2/CH4} and P_{CO2}. Both α_{CO2/CH4} and P_{CO2} increased by 38% compared to the “control” poly(BTDA-PMDA-ODPA-TMMDA) polymer dense film for CO₂/CH₄ separation, suggesting that this 30% AlPO-14/PES/poly(BTDA-PMDA-ODPA-TMMDA) MMM is a good membrane candidate for the removal of CO₂ from natural gas or flue gas.

TABLE 4
Pure gas permeation test results of “Control” poly(BTDA-
PMDA-ODPA-TMMDA) polymer dense film and 30%
AlPO-14/PES/poly(BTDA-PMDA-ODPA-TMMDA)
mixed matrix dense film for CO₂/CH₄ separation^{a}

| | P_{CO2} | ΔP_{CO2} | | |
|---|---|---|---|---|
| Dense film | (Barrer) | (Barrer) | α_{CO2/CH4} | Δα_{CO2/CH4} |
| “Control” poly(BTDA- | 55.5 | 0 | 17.0 | 0 |
| PMDA-ODPA-TMMDA) | | | | |
| 30% AlPO- | 76.8 | 38% | 23.4 | 38% |
| 14/PES/poly(BTDA- | | | | |
| PMDA-ODPA-TMMDA) | | | | |

^{a}Tested at 50° C. under 690 kPa (100 psig) pure gas pressure; 1 Barrer = 10⁻¹⁰ (cm³(STP) · cm)/(cm² · sec · cmHg)

### Example 15

### H₂/CH₄ Separation Properties of “Control” poly(BTDA-PMDA-ODPA-TMMDA) Polymer Dense Film and 30% AlPO-14/PES/poly(BTDA-PMDA-ODPA-TMMDA) Mixed Matrix Dense Film

The permeabilities (P_{H2} and P_{CH4}) and selectivity α_{H2/CH4}) of the “control” poly(BTDA-PMDA-ODPA-TMMDA) polymer dense film prepared in Example 12 and 30% AlPO-14/PES/poly(BTDA-PMDA-ODPA-TMMDA) mixed matrix dense film PES functionalized AlPO-14 fillers prepared in Example 13 were measured by pure gas measurements at 50° C. under about 690 kPa (100 psig) pressure using a dense film test unit. The results for H₂/CH₄ separation are shown in Table 5.

It can be seen from Table 5 that the 30% AlPO-14/PES/poly(BTDA-PMDA-ODPA-TMMDA) MMM showed significant simultaneous increase in both α_{H2/CH4} and P_{H2}. Both α_{H2/CH4} and P_{H2} increased by 49% compared to the “control” poly(BTDA-PMDA-ODPA-TMMDA) polymer dense film for H₂/CH₄ separation, suggesting that this 30% AlPO-14/PES/poly(BTDA-PMDA-ODPA-TMMDA) MMM is a good membrane candidate for the removal of H₂ from natural gas.

TABLE 5
Pure gas permeation test results of “Control” poly(BTDA-
PMDA-ODPA-TMMDA) polymer dense film and 30%
AlPO-14/PES/poly(BTDA-PMDA-ODPA-TMMDA)
mixed matrix dense film for H₂/CH₄ separation^{a}

| | P_{H2} | ΔP_{H2} | | |
|---|---|---|---|---|
| Dense film | (Barrer) | (Barrer) | α_{H2/CH4} | Δα_{H2/CH4} |
| “Control” poly(BTDA-PMDA- | 99.9 | 0 | 30.6 | 0 |
| ODPA-TMMDA) | | | | |
| 30% AlPO-14/PES/poly(BTDA- | 149.3 | 49% | 45.5 | 49% |
| PMDA-ODPA-TMMDA) | | | | |

^{a}Tested at 50° C. under 690 kPa (100 psig) pure gas pressure; 1 Barrer = 10⁻¹⁰ (cm³(STP) · cm)/(cm² · sec · cmHg)

### Example 16

### Propylene/propane Separation Properties of “Control” poly(BTDA-PMDA-ODPA-TMMDA) Polymer Dense Film and 30% AlPO-14/PES/poly(BTDA-PMDA-ODPA-TMMDA) Mixed Matrix Dense Film

The permeabilities of propylene (C3=) and propane (C3) (P_{C3=} and P_{C3}) and ideal selectivity for propylene/propane (α_{C3=C3}) of the “control” poly(BTDA-PMDA-ODPA-TMMDA) polymer dense film prepared in Example 12 and 30% AlPO-14/PES/poly(BTDA-PMDA-ODPA-TMMDA) mixed matrix dense film containing PES functionalized AlPO-14 fillers prepared in Example 13 were measured by pure gas measurements at 50° C. under about 207 kPa (30 psig) pressure using a dense film test unit. The results are shown in Table 6.

It can be seen from Table 6 that the 30% AlPO-14/PES/poly(BTDA-PMDA-ODPA-TMMDA) MMM showed significant increase in α_{C3=/C3}. The α_{C3=/C3} increased by 42% compared to the “control” poly(BTDA-PMDA-ODPA-TMMDA) polymer dense film for propylene/propane separation, suggesting that this 30% AlPO-14/PES/poly(BTDA-PMDA-ODPA-TMMDA) MMM is a good membrane candidate for olefin/paraffin separations such as propylene/propane separation.

TABLE 6
Pure gas permeation test results of “Control” poly(BTDA-
PMDA-ODPA-TMMDA) polymer dense film and 30%
AlPO-14/PES/poly(BTDA-PMDA-ODPA-TMMDA)
mixed matrix dense film for propylene/propane separation^{a}

| Dense film | P_{C3=}(Barrer) | α_{C3=/C3} | Δα_{C3=/C3} |
|---|---|---|---|
| “Control” poly(BTDA-PMDA- | 1.56 | 11.1 | 0 |
| ODPA-TMMDA) | | | |
| 30% AlPO-14/PES/poly(BTDA- | 1.67 | 15.8 | 42% |
| PMDA-ODPA-TMMDA) | | | |

* C3= represents propylene, C3 represents propane, P_{C3=} and P_{C3} were tested at 50° C. and 207 kPa (30 psig); 1 Barrer = 10⁻¹⁰ cm³(STP) · cm/cm² · sec · cmHg

### Example 17

### Preparation of 30% UZM-25/PES/poly(DSDA-TMMDA) Mixed Matrix Dense Film

A 30% UZM-25/PES/poly(DSDA-TMMDA) mixed matrix dense film incorporating PES functionalized UZM-25 molecular sieves (abbreviated as 30% UZM-25/PES/poly(DSDA-TMMDA) in Table 7) was prepared using similar procedures as described in Example 2, but replacing AlPO-14 by UZM-25 and the weight ratio of UZM-25 to poly(DSDA-TMMDA) and PES is 30:100.

### Example 18

### CO₂/CH₄ Separation Properties of “Control” poly(DSDA-TMMDA) Polymer Dense Film and 30% UZM-25/PES/poly(DSDA-TMMDA) Mixed Matrix Dense Film

The permeabilities of CO₂ and CH₄ (P_{CO2} and P_{CH4}) and selectivity for CO₂/CH₄ (α_{CO2/CH4}) of the “control” poly(DSDA-TMMDA) polymer dense film prepared in Example 1 and 30% UZM-25/PES/poly(DSDA-TMMDA) mixed matrix dense film prepared in Example 17 were measured by pure gas measurements at 50° C. under about 690 kPa (100 psig) pressure using a dense film test unit. The results for CO₂/CH₄ separation are shown in Table 7.

It can be seen from Table 7 that the 30% UZM-25/PES/poly(DSDA-TMMDA) mixed matrix dense film showed simultaneous α_{CO2/CH4} increase by 31% and P_{CO2} increase by 44% for CO₂/CH₄ separation compared to those of the “control” poly(DSDA-TMMDA) polymer dense film. The α_{CO2/CH4} increased to 32.5 and P_{CO2} increased to 26.7 barrers when 30 wt-% of UZM-25 molecular sieve fillers were incorporated into poly(DSDA-TMMDA) polymer matrix which has α_{CO2/CH4} of 24.8 and P_{CO2} of 18.5 barrers, suggesting that UZM-25 is a suitable molecular sieve filler (micro pore size: 2.5×4.2 Å and 3.1×4.2 Å) with molecular sieving mechanism for the preparation of high selectivity molecular sieve/polymer mixed matrix membranes for CO₂/CH₄ gas separation.

TABLE 7
Pure gas permeation test results of poly(DSDA-TMMDA)
polymer dense film and 30% UZM-25/PES/poly(DSDA-TMMDA)
mixed matrix dense film for CO₂/CH₄ separation^{a}

| | P_{CO2} | ΔP_{CO2} | | |
|---|---|---|---|---|
| Membrane | (Barrer) | (Barrer) | α_{CO2/CH4} | Δα_{CO2/CH4} |
| poly(DSDA-TMMDA) | 18.5 | 0 | 24.8 | 0 |
| 30% UZM-25/PES/ | 26.7 | 44% | 32.5 | 31% |
| poly(DSDA-TMMDA) | | | | |

^{a}Tested at 50° C. under 690 kPa (100 psig) pure gas pressure; 1 Barrer = 10⁻¹⁰ (cm³(STP) · cm)/(cm² · sec · cmHg)

### Example 19

### Preparation of “Control” CA-CTA Polymer Dense Film

2.67 g of cellulose acetate (CA) polymer and 5.33 g of cellulose triacetate (CTA) were dissolved in a solvent mixture of 23.5 g of 1,4-dioxane and 10.0 g of acetone by mechanical stirring for 3 hours to form a homogeneous solution. Then 1.2 g of lactic acid was added to the solution and the resulting mixture was stirred for another 1 hour to form a stable casting dope. The resulting homogeneous casting dope was allowed to degas overnight. A “control” CA-CTA polymer dense film was prepared from the bubble free casting dope on a clean glass plate using a doctor knife with a 20-mil gap. The dense film together with the glass plate was then put into a vacuum oven. The solvents were removed by slowly increasing the vacuum and the temperature of the vacuum oven. Finally, the dense film was dried at 150° C. under vacuum for at least 48 hours to completely remove the residual solvents to form the “control” CA-CTA polymer dense film (abbreviated as “control” CA-CTA in Table 8).

### Example 20

### Preparation of “Comparative” 30% AlPO-14/CA-CTA Mixed Matrix Dense Film

2.4 g of AlPO-14 molecular sieves were dispersed in a mixture of 23.5 g of 1,4-dioxane and 10.0 g of acetone by mechanical stirring and ultrasonication for 1 hour to form a slurry. Then 2.67 g of CA polymer and 5.33 g of CTA were added to the slurry together and the resulting mixture was stirred for another 3 hours to form a casting dope containing 30 wt-% of AlPO-14 molecular sieves (weight ratio of AlPO-14 to CA and CTA is 30:100; weight ratio of CA to CTA is 1:2) in the continuous CA-CTA polymer matrix. The casting dope was allowed to degas overnight.

A “comparative” 30% AlPO-14/CA-CTA mixed matrix dense film was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the dense film was dried at 150° C. under vacuum for at least 48 hours to completely remove the residual solvents to form “comparative” 30% AlPO-14/CA-CTA mixed matrix dense film (abbreviated as “comparative” 30% AlPO-14/CA-CTA in Table 8).

### Example 21

### Preparation of 30% AlPO-14/CTA/CA Mixed Matrix Dense Film

2.4 g of AlPO-14 molecular sieves were dispersed in a mixture of 23.5 g of 1,4-dioxane and 10.0 g of acetone by mechanical stirring and ultrasonication for 1 hour to form a slurry. Then 2.67 g of CTA polymer was added to the slurry to functionalize AlPO-14 molecular sieves in the slurry. The slurry was stirred for at least 2 hours to completely dissolve CTA polymer and functionalize the surface of AlPO-14. CTA was used as the surface functionalizing agent to functionalize the outer surface of AlPO-14 molecular sieves. After that, 5.33 g of CA polymer was added to the slurry and the resulting mixture was stirred for another 2 hours to form a stable casting dope containing 30 wt-% of dispersed CTA functionalized AlPO-14 molecular sieves (weight ratio of AlPO-14 to CA and CTA is 30:100; weight ratio of CA to CTA is 1:2) in the continuous CA-CTA polymer matrix. The stable casting dope was allowed to degas overnight.

A 30% AlPO-14/CTA/CA mixed matrix dense film was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the dense film was dried at 150° C. under vacuum for at least 48 hours to completely remove the residual solvents to form 30% AlPO-14/CTA/CAmixed matrix dense film (abbreviated as 30% AlPO-14/CTA/CA in Table 8).

### Example 22

### CO₂/CH₄ Separation Properties of “Control” CA-CTA Polymer Dense Film, “Comparative” 30% AlPO-14/CA-CTA Mixed Matrix Dense Film and 30% AlPO-14/CTA/CA Mixed Matrix Dense Film

The permeabilities of CO₂ and CH₄ (P_{CO2} and P_{CH4}) and selectivity for CO₂/CH₄ (α_{CO2/CH4}) of the “control” CA-CTA polymer dense film prepared in Example 19, “comparative” 30% AlPO-14/CA-CTA mixed matrix dense film prepared in Example 20, and 30% AlPO-14/CTA/CA mixed matrix dense film prepared in Example 21 were measured by pure gas measurements at 50° C. under about 690 kPa (100 psig) pure gas pressure. The results for CO₂/CH₄ separation are shown in Table 8. It can be seen from Table 8 that the 30% AlPO-14/CTA/CA mixed matrix dense film showed 43% increase in P_{CO2} and 28% increase in α_{CO2/CH4} compared to the “control” CA-CTA polymer dense film for CO₂/CH₄ separation at 50° C. under about 690 kPa (100 psig) pure gas pressure. However, the “comparative” 30% AlPO-14/CA-CTA mixed matrix dense film prepared without using CTA to functionalize the surface of AlPO-14 showed 11% decrease in α_{CO2/CH4} compared to the “control” CA-CTA polymer dense film for CO₂/CH₄ separation at 50° C. under about 690 kPa (100 psig) pure gas pressure. These results suggest that functionalization of AlPO-14 molecular sieve surface using CTA polymer is an effective method to improve the compatibility and adhesion at the AlPO-14/CA interface, resulting in macrovoids and defect free mixed matrix dense films.

TABLE 8
Pure gas permeation test results of CA-CTA polymer dense film,
“comparative” 30% AlPO-14/CA-CTA mixed matrix dense
film and 30% AlPO-14/CTA/CA mixed matrix dense film
for CO₂/CH₄ separation^{a}

| | P_{CO2} | ΔP_{CO2} | | |
|---|---|---|---|---|
| Membrane | (Barrer) | (Barrer) | α_{CO2/CH4} | Δα_{CO2/CH4} |
| “control” CA-CTA | 8.83 | 0 | 21.3 | 0 |
| “comparative” 30% | 12.3 | 39% | 19.2 | −11% |
| AlPO-14/CA-CTA | | | | |
| 30% AlPO-14/CTA/CA | 12.6 | 43% | 27.2 | 28% |

^{a}Tested at 50° C. under 690 kPa (100 psig) pure gas pressure; 1 Barrer = 10⁻¹⁰ (cm³(STP) · cm)/(cm² · sec · cmHg)

1. A membrane comprising a void free and defect free first polymer functionalized molecular sieve/second polymer mixed matrix membrane comprising a molecular sieve, a first polymer used to functionalize said molecular sieve, and a second polymer used as a continuous polymer matrix, wherein said first polymer is used to functionalize the outer surface of the said molecular sieve via covalent or hydrogen bonds, and wherein said first polymer and said second polymer are different polymers.

2. The membrane of claim 1 wherein said second polymer is not used to functionalize the outer surface of the said molecular sieve.

3. The membrane of claim 1 wherein said first polymer and said polymer b are miscible with each other.

4. The membrane of claim 1 wherein said molecular sieve is selected from the group consisting of microporous and mesoporous molecular sieves, carbon molecular sieves, and porous metal-organic frameworks (MOFs).

5. The membrane of claim 4 wherein said microporous molecular sieve is a zeolite based on an aluminosilicate composition or a non-zeolite based on aluminophosphate, silico-aluminophosphate, or silica composition.

6. The membrane of claim 4 wherein said microporous molecular sieves are selected from the group consisting of SAPO-34, Si-DDR, UZM-9, AlPO-14, AlPO-34, AlPO-17, SSZ-62, SSZ-13, AlPO-18, AlPO-53, ERS-12, CDS-1, MCM-65, MCM-47, 4A, 5A, UZM-5, UZM-25, UZM-12, silicalite-1, SSZ-16, AlPO-34, SAPO-44, SAPO-47, SAPO-17, CVX-7, SAPO-35, SAPO-56, AlPO-52, SAPO-43, NaX, NaY, and CaY.

7. The membrane of claim 4 wherein said microporous molecular sieves are selected from the group consisting of AlPO-18, AlPO-53, AlPO-14, AlPO-17, UZM-5, UZM-25, ERS-12, CDS-1, MCM-65, CVX-7, SAPO-34, SAPO-56, and mixtures thereof.

8. The membrane of claim 4 wherein said mesoporous molecular sieves are selected from the group consisting of MCM-41, SBA-15, and surface functionalized MCM-41 and SBA-15.

9. The membrane of claim 4 wherein said porous metal-organic frameworks are selected from the group consisting of IRMOF-1, Cu₃(BTC)₂ MOF, and mixtures thereof.

10. The membrane of claim 1 wherein said molecular sieve is a sub-micron size molecular sieve with particle size in the range of 5 to 1000 nm.

11. The membrane of claim 10 wherein said sub-micron size molecular sieve is selected from the group consisting of SAPO-34, Si-DDR, UZM-9, AlPO-14, AlPO-34, AlPO-17, SSZ-62, SSZ-13, AlPO-53, AlPO-18, ERS-12, CDS-1, MCM-65, MCM-47, 4A, 5A, UZM-5, UZM-25, UZM-12, silicalite-1, SSZ-16, AlPO-34, SAPO-44, SAPO-47, SAPO-17, CVX-7, SAPO-35, SAPO-56, AlPO-52, SAPO-43, IRMOF-1, Cu₃(BTC)₂ MOF, and mixtures thereof.

12. The membrane of claim 1 wherein there are covalent or hydrogen bonds between said molecular sieve and said first polymer.

13. The membrane of claim 1 wherein said first polymer is selected from the group consisting of polyethersulfones, cellulose triacetate, sulfonated polyethersulfones, hydroxyl group-terminated poly(ethylene oxide)s, amino group-terminated poly(ethylene oxide)s, or isocyanate group-terminated poly(ethylene oxide)s, poly(esteramide-diisocyanate)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(allyl amine)s, and poly(vinyl amine)s.

14. The membrane of claim 1 wherein said first polymer is polyethersulfone.

15. The membrane of claim 1 wherein said second polymer is selected from the group consisting of polyimides, polyetherimides, polyamides, cellulose acetate, cellulose triacetate, and microporous polymers.

16. The membrane of claim 1 wherein said void free and defect free first polymer functionalized molecular sieve/second polymer mixed matrix membrane is used to separate organic compounds from water.

17. The membrane of claim 16 wherein said organic compounds are selected from the group consisting of alcohol, phenols, chlorinated hydrocarbons, pyridines, ketones and mixtures thereof.

18. The membrane of claim 1 wherein said void free and defect free first polymer functionalized molecular sieve/second polymer mixed matrix membrane is used to separate isomers of organic compounds.

19. The membrane of claim 1 wherein said void free and defect free first polymer functionalized molecular sieve/second polymer mixed matrix membrane is used to separate organic compounds selected from the group of pairs of compounds consisting of ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.
